(19) United States
(12) Patent Application Publication
(10) Pub. No.: US 2011/0206422 A1
(43) Pub. Date: Aug. 25, 2011

(54) INTERMEDIATE TRANSFER MEMBER

(75) Inventors: Tatsuya Hirose, Tokyo (JP); Yuichiro Maehara, Tokyo (JP)

(73) Assignee: KONICA MINOLTA BUSINESS TECHNOLOGIES, INC., Tokyo (JP)

(21) Appl. No.: 12/993,989

(22) PCT Filed: May 26, 2009
(86) PCT No.: PCT/JP2009/059578

§ 371 Date: Nov. 22, 2010

(30) Foreign Application Priority Data
May 26, 2008 (JP) 2008-136361
May 27, 2008 (JP) 2008-137729

(51) Int. Cl. G03G 15/16

(52) U.S. Cl. 399/308

(57) ABSTRACT

Disclosed is an intermediate transfer member that, for example, even when a large number, for example, 160,000 sheets of prints are prepared, does not cause cracking and toner filming, can allow good transfer properties and cleaning properties to be maintained, and can realize stable preparation of toner images having a high quality free from image defects such as lack of text image. In the intermediate transfer member, an elastic layer is provided on the outer circumference of a resin substrate, and a surface layer is provided on the elastic layer. The surface layer has a thickness of 0.5 nm or more but 1000 nm or less and comprises an intermediate layer and a hard layer composed mainly of a metal oxide. The layer density of the hard layer is 2.07 g/cm³ or more but 2.19 g/cm³ or less and is larger than the layer density of the intermediate layer.

### CROSS REFERENCE TO RELATED APPLICATIONS

This is a U.S. national stage application of International Application No. PCT/JP2009/059578, filed on 26 May 2009. Priority under 35 U.S.C. §119(a) and 35 U.S.C. §365(b) is claimed from Japanese Application Nos. 2008-136361, filed 26 May 2008, and 2008-137729, filed 27 May 2008, the disclosure of each of which are also incorporated herein by reference.

### TECHNICAL FIELD

The present invention relates to an intermediate transfer member.

The present invention relates to an intermediate transfer member having an elastic layer, and specifically to an intermediate transfer member having a surface layer containing at least a hard layer and an intermediate layer provided on an elastic layer.

### TECHNICAL BACKGROUND

As a system to transfer a toner image formed on a surface of an electrophotographic photoreceptor (hereinafter, also denoted simply as a photoreceptor) onto a recording material in an image forming method employing electrophotography, there has been known an image forming system using a belt like or a drum-like member called an intermediate transfer member, besides a method to directly transfer a toner image from a photoreceptor to a transfer material.

Such a system contains two transfer steps, namely, a primary transfer step in which a toner image is transferred from an electrophotographic photoreceptor to an intermediate transfer member, and a secondary step in which the toner image formed on the intermediate transfer member is transferred to a transfer material. The intermediate transfer method is mainly used for a so-called full color image forming method employing a plurality of colors such as black, cyan, magenta and yellow. Namely, each color toner image formed on a plurality of photoreceptors is sequentially transferred primarily onto an intermediate transfer member to juxtapose the color toner images, and thus formed full color toner image is transferred onto a transfer material, whereby a full color print is prepared.

For the intermediate transfer member, high durability has been required because transfer of the toner image and removal of remained toner after transferring the toner image are repeated on the surface. Accordingly, high durability resins represented by a polyimide resin have been utilized. However, there has been a problem in that it has been difficult to uniformly transfer the toner image formed on the photoreceptor onto the intermediate member without unevenness because the member constituted of such a material tends to be hard.

Thus, due to the presence of such a hard resin member, it has been difficult to uniformly transfer the toner image formed on a photoreceptor onto an intermediate transfer member without unevenness, whereby an image defect so called lack of toner image has often appeared, the lack of text image defect being an image defect which cause lack of toner in some positions which should have toner. Specifically, this problem notably has occurred when a text image is formed and has given a significant effect on the image quality. Also, contamination of the image or contamination of inside of the apparatus has occurred according to the toner scattering due to the toner remained on the photoreceptor without transferred to the intermediate transfer member. Consequently, a technique to provide an elastic layer on the intermediate transfer member in order to surely transfer the toner image formed on the photoreceptor onto the intermediate transfer member has come to be examined (for example, refer to Paten Documents 1-3).

By the way, in the case of transferring a toner image transferred on the surface of an intermediate transfer member onto a transfer material such as a paper sheet, certain extent of hardness has been desired for an intermediate transfer member, since the transfer of a toner image becomes difficult when the intermediate transfer member surface is too soft. Either one of the techniques disclosed in the above Patent Documents has considered forming another layer on the elastic layer, for example, an inorganic coating layer, in view of avoiding deterioration of transfer property or enhancing the durability.

For example, the technique disclosed in Patent Document 1 was made to avoid a transferring error and image drifting, even after formation of 600,000 full color images, by providing an inorganic coating layer of which thickness was 0.1-70 μm.

Alternatively, Patent Document 2 discloses a conveyance belt having an intermediate layer between a surface layer constitute of a diamond-like-carbon layer and a belt material constitute of an elastic material to adhere both the layers. Further, Patent Document 3 discloses a technique to form an intermediate transfer member having a structure in which a fluorine-containing compound is chemically bonded on the surface of an elastic material of a semiconductive endless belt constitute of an elastic material by means of an atmospheric pressure plasma technique.

Thus, investigation of an intermediate transfer member has been progressed, in which a transferring property is assured and durability is enhanced by providing another layer on the elastic layer as well as providing an elastic layer on the intermediate transfer member.

### PRIOR ARTS

### Patent Documents

Patent document 1: Japanese Patent Application Publication Open to Public Inspection (hereafter referred to as JP-A) No. 2000-206801

Patent document 2: JP-A No. 2006-259581

Patent document 3: JP-A No. 2003-165857

### DISCLOSURE OF THE INVENTION

### Problem to be Solved by the Invention

By the way, according to the recent progress in digital technologies and a technique to produce a small diameter toner, a high resolution image such as a photographic image has come to be formed via an electrophotographic image forming method. Since it has become possible to form such a high quality image, prints of, for example, photographic images has come to be formed via a photographic method, as a result, a new print business so called on-demand printing has come to be developed. This print business so called on-demand printing has a merit that prints of a desired number of sheets can be timely offered without making a plate.

In such a print business field, even a case in which an order of a large number of printmaking, for example, exceeding 160,000 sheets is made is highly expected. For example, in the print business field, the following case may be expected to occur, in which more than 1000 of booklets each containing prints of around 200 pages are ordered at a time. Accordingly, an intermediate transfer member which has many opportunities to produce a full color print has come to be desired to stably form high quality prints without image defects, even under such a circumstance.

However, the technique disclosed in above-mentioned Patent Document 1 teaches a technique which enables printing of a level of 60,000 sheets, and it has been difficult to deduce whether the technique is tolerable for formation of 160,000 or more prints from the statement of the above-mentioned patent document. Specifically, in the technique of Patent Document 1, the cleaning property is improved by providing an inorganic coating layer on the elastic member to increase the friction tolerance, whereby the stain of the surface of the intermediate transfer member by the toner is prevented. In this technique, the binder for the colloidal silica is an organic layer, and, when formation of 160,000 prints is carried out, it is concerned that the organic layer is scraped away to form scratches which form toner filming. It is also concerned that, when the amount of colloidal silica is increased in order to improve the friction tolerance, cracks become more sassily to occur.

Further, the technique disclosed by Patent Document 2 teaches that a cover layer exhibiting high hardness and flatness is provided on the elastic member, however, it is cinsidered from its structure that the cover layer on the elastic member is too hard and it is difficult to sufficiently transfer the image from the photoreceptor to the intermediate transfer member, whereby generation of aforementioned lack of text images or scattering toner is suspected.

Further, in the technique disclosed by Patent Document 3, it is considered to be difficult to keep enough mechanical strength as well as it is considered to be difficult to sufficiently transfer the image onto the transfer material, since the layer of the fluorine compound formed on the surface is thought to be very soft. Therefore, it is concerned that the intermediate transfer member is abraded to form scratches while the contact with a cleaning blade is repeated, whereby the image quality is deteriorated.

Thus, with respect to an intermediated transfer member having an elastic layer on which another layer is provided, it has been thought to be difficult to easily form a large number of prints, for example, exceeding 160,000 prints, since there have been a problem in successfully carrying out transfer of the toner image, both from a photoreceptor to an intermediate transfer member and from an intermediate transfer member to a transfer material, in a good balance, and a problem in deterioration of the durability due the formation of an elastic layer.

It is an object of the present invention to provide an intermediate transfer member which enables to maintain superior secondary transferability and superior cleaning property without forming cracks and toner filming and is also capable to stably obtain toner images of high quality without lack of text images even after making prints of a large number of sheets exceeding, for example, 160,000 sheets.

### Means to Solve the Problem

The present invention is achieved by the following structures.

1. An intermediate transfer member used for transferring a toner image carried on a surface of an electrophotographic photoreceptor primarily to the intermediate transfer member, and secondarily transferring the toner image from the intermediate transfer member to a transfer material, wherein the intermediate transfer member is formed by providing an elastic layer on an outer circumference of a resin substrate and further thereon a surface layer, wherein

the surface layer has a layer thickness of 0.5 nm or more but 1000 nm or less,

the surface layer comprises an intermediate layer and a hard layer, the hard layer having a metal oxide as a main component, and

a layer density of the hard layer is 2.07 g/cm³ or more but 2.19 g/cm³ or less, while the layer density of the hard layer is larger than a layer density of the intermediate layer.

2. The intermediate transfer member of Item 1, wherein an elastic modulus of the hard layer is 8.0 GPa or more but 60.0 GPa or less, while the elastic modulus of the hard layer is larger than an elastic modulus of the intermediate layer.

3. The intermediate transfer member of Item 1 or 2, wherein a carbon content of the intermediate layer is larger than a carbon content of the hard layer.

4. The intermediate transfer member of any one of Items 1 to 3, wherein the surface layer is formed by laminating one or more layers of a metal oxide, a carbon-containing organic metal and amorphous carbon.

5. The intermediate transfer member of any one of Items 1 to 4, wherein the hard layer is a lay containing silicon oxide as a main component.

6. The intermediate transfer member of any one of Items 1 to 5, wherein the intermediate layer contains silicon oxide as a main component and further contains 1.0 atomic % to 20.0 atomic % of carbon atoms.

7. The intermediate transfer member of any one of Items 1 to 6, wherein the surface layer is prepared via a plasma CVD method conducted under an atmospheric pressure or vicinity thereof, wherein two or more electric fields each having a different frequency are formed in the plasma CVD method.

8. The intermediate transfer member of any one of Items 1 to 7, wherein a compression stress of the surface layer is 30 MPa or less.

9. The intermediate transfer member of any one of Items 1 to 8, wherein the elastic layer is a layer formed of at least one of a chloroprene rubber, a nitrile rubber and an ethylene-propylene copolymer.

10. The intermediate transfer member of any one of Items 1 to 9, wherein the resin substrate is formed of at least one of a polyimide, a polycarbonate and a poly (phenylene sulfide).

### Effect of the Invention

The intermediate transfer member of the present invention achieves superior advantageous effects, which enables to maintain superior primary and secondary transferability and enhanced cleaning property, without forming cracks and toner filming, and is also capable of continuing to obtain high quality toner images without lack of text images even when making prints of a large number of sheets, for example, 160,000 sheets. Accordingly, it is expected that the intermediate transfer member of the present invention promotes the spreading of an image forming apparatus employing an electrophotographic method into the field of on-demand printing in which desired number of prints are quickly and timely prepared without making a printing plate.

### BRIEF DESCRIPTION OF THE DRAWINGS

FIG. 1 illustrate a section showing a layer arrangement of an intermediate transfer member.

FIG. 2 is a view showing a measurement device employing the nanoindentation method.

FIG. 3 illustrates a first production apparatus to produce a surface layer of an intermediate transfer member.

FIG. 4 illustrates a second production apparatus to produce a surface layer of an intermediate transfer member.

FIG. 5 illustrates a first plasma film forming apparatus to produce a surface layer of an intermediate transfer member by plasma.

FIGS. 6a and 6b each show a schematic view of an example of a roll electrode.

FIGS. 7a and 7b each show a schematic view of an example of a fixed electrode.

FIG. 8 is a sectional view showing an example of an image forming apparatus capable of employing an intermediate transfer member of the present invention.

### PREFERRED EMBODIMENTS OF THE INVENTION

The intermediate transfer member of the present invention has a structure in which an elastic layer is formed on the outer circumference of a resin substrate, further having thereon a surface layer constitute of an intermediate layer and a hard layer. It was found in the present invention that the problem could be solved by making the density of the hard layer forming the surface layer larger than the density of the intermediate layer, while controlling the thickness of the surface layer. Namely, according to the intermediate transfer member of the present invention, for example, the following effects were obtained: generation of cracks or toner filming was prevented, the transferability was improved and maintained, the cleaning property was maintained, and generation of lack of text image was prevented, even after continuously forming a large number of prints, for example, exceeding a level of 160,000 sheets of prints.

The reason why the intermediate transfer member which has the structure of the present invention exhibits the aforementioned effects even after continuously carrying out a large number of printing, for example, a level of exceeding 160,000 sheets is not still clear, however, it is deduced to be based on the following reasons.

First, it is considered that the intermediate transfer member of the present invention forms the state of smoothly adhering the toner image on a photoreceptor onto the intermediate transfer member in the primary transfer process, and forms the state of surely transferring the toner on the intermediate transfer member onto a transfer material in the secondary transfer process, these conditions being achieved by prescribing the elasticity of the surface layer.

Namely, it is supposed that, in the primary transfer process, a sufficient contact area to fully support the toner is formed by the transformation of the intermediate transfer member surface due to the pressing force from the photoreceptor. Alternatively, it is supposed that, in the secondary transfer process, the transformation of the intermediate transfer member due to the pressing force is recovered and the contact area with the toner is reduced, whereby a suitable condition for transferring the toner onto the transfer material is formed.

Thus, in the intermediate transfer member of the present invention, it is considered that the elasticity and the hardness are exhibited in a suitable balance, namely, in the primary transfer process, the adhering function of the toner is promoted by the transformation due to the pressing force, and, in the secondary transfer process, the transformation due to the pressing force is released and the functions to release and transfer the toner are promoted. As a result, it is considered that a stable transfer function is maintained since the transformation and the shrinkage can be repeated in a short time even when a large number of printing is carried out.

Further, in the present invention, it is considered that a stabilized electric potential on the surface of the intermediate transfer member has come to be maintained without loosing the electrical conductivity of the resin substrate by prescribing the thickness of the surface layer and providing a hard layer containing a metal oxide on the outermost surface of the intermediate transfer member. As a result, it is considered that scattering of toner to the periphery of the image is avoided even when a large number of printing is carried out. Also, it is considered that, according to this constitution, the mechanical strength of the intermediate transfer member is increased, whereby too much abrasion of the surface of the intermediate transfer member is avoided and lubricity and abrasion resistance are stably exhibited.

Further, in the present invention, it is supposed that generation of cracks or peeling off of the hard layer is prevented by providing an intermediate layer which is softer than the hard layer and harder than the elastic layer, whereby the intermediate layer works as a cushion between these layers.

Further, since the elasticity and the hardness are exhibited in a suitable balance and the mechanical strength of the surface is stably maintained, as described above, it is considered that the intermediate transfer member of the present invention has come to be free from scratches even when it is repeatedly scraped by a cleaning member, whereby residual toner after transferring has come to be removed for a long time. As a result, it is considered that a print sheet having a high quality toner image which is free from a stain of the image caused by a cleaning error has come to be stably presented, even after forming a large number of prints exceeding 160,000 print sheets.

According to the above reasons, it is considered that, in the intermediate transfer member of the present invention, a high transfer property is maintained for a long time and an image defect so called as lack of text image can be avoided for a long time even when a large amount of prints, for example, exceeding a level of 160,000 are formed. Further, it is considered that no crack or no toner filming is formed, and also no abrasion or no crack due to scrape by a cleaning member is formed. As a result, it is considered that high quality images are stably formed.

The present invention will be further described below.

### (Layer Constitution of Intermediate Transfer Member)

First, the layer constitution of the intermediate transfer member of the present invention will be described.

The intermediate transfer member of the present invention has a structure in which an elastic layer is formed on the outer peripheral of a resin substrate, and a surface layer is further provided on the elastic layer. The above mentioned surface layer is formed from at least one hard layer and at least one intermediate layer.

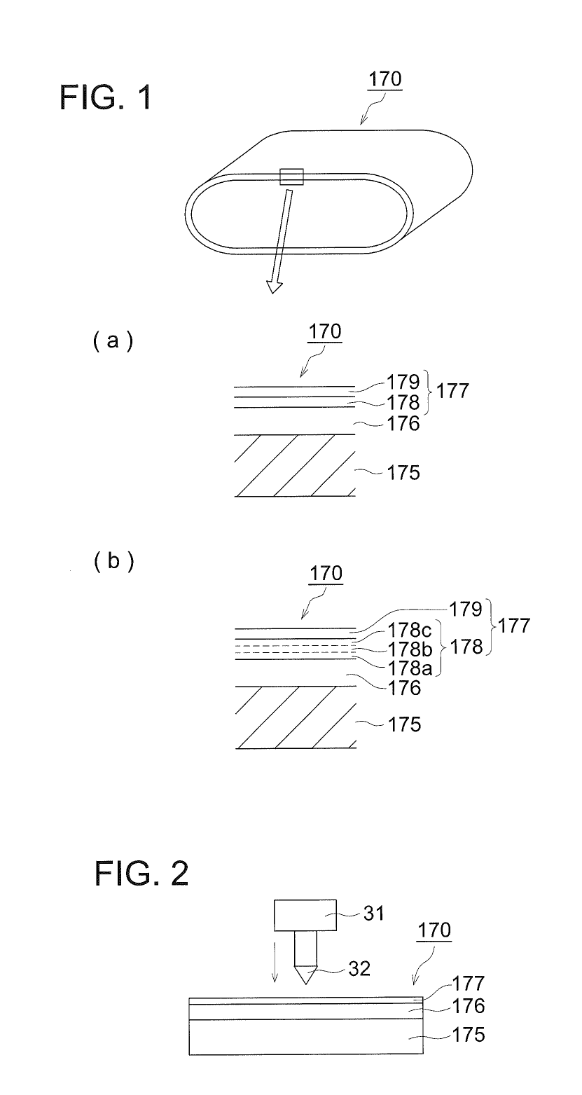

FIG. 1 illustrates an oblique view of the intermediate transfer member according to the present invention and its section showing an example of the layer arrangement. The layer arrangement of the intermediate transfer member according to the present invention is not limited to the layer arrangement shown in FIG. 1.

The intermediate transfer member shown in FIG. 1 has a belt-like shape, and normally called as an intermediate transfer belt. In FIG. 1, the numeral 170 designates an intermediate transfer member, the numeral 175 designates a resin substrate, the numeral 176 designates an elastic layer, the numeral 177 designates a surface layer, and the surface layer 177 is formed by an intermediate layer 178 and a hard layer 179. The intermediate layer 178 may have a multi-layer structure as shown in (b) of FIG. 1, for example, a first intermediate layer 178a, a second intermediate layer 178b and a third intermediate layer 178c.

Illustrated in (a) of FIG. 1 is an intermediate transfer member 170 of a layer arrangement in which an elastic layer 176 is provided on the outer circumference of a resin substrate 175 and thereon, an intermediate layer 178 and a hard layer 179 as a surface layer 177 is provided.

Illustrated in (b) of FIG. 1 is an example in which an elastic layer 176 is provided on the outer circumference of a resin substrate 175 in the same manner as shown in (a) of FIG. 1, and illustrates an intermediate transfer member 170 of a layer arrangement in which an surface layer 177 provided on an elastic layer 176 is formed by an intermediate layer 178 constituted of 3 layers (178a, 178b and 178c) and a hard layer 179 provided thereon.

The layer arrangement of an intermediate transfer member may be preferably either (a) or (b) of FIG. 1. Of these, the layer arrangement of (b) in FIG. 1 in which the intermediate layer 178 has a multi-layer structure is preferred in terms of improving the transferability.

The resin substrate 175 and the elastic layer 176 constituting the intermediate transfer member 170 will be described later.

### (Description of Surface Layer)

### <Constitution of Surface Layer>

The surface layer constituting the intermediate transfer member according to the present invention is constituted of at least an intermediate layer and a hard layer containing a metal oxide as a main component.

The surface layer can be formed by using at least one or more of a metal oxide, a carbon-containing organometal and an amorphous carbon. It is also possible to form a laminated structure using plural kinds of these compounds.

The thickness of the surface layer constituting the intermediate transfer member according to the present invention (hereafter, referred merely to as thickness) is 0.5 nm or more, but 1000 nm or less, and preferably 3 nm or more, but 500 nm or less.

By setting the thickness of the surface layer to be 0.5 nm or more, durability and surface strength become satisfactory, no scratch is formed when transferring to a thick paper sheet, and no deterioration of transfer ratio nor unevenness in transfer due to abrasion of the film occurs. By setting the thickness of the surface layer to be 100 nm or less, no degradation of adhesiveness to the elastic layer nor insufficient bending resistance occurs, no crack nor exfoliation of the film occurs even after a large number of printing, and the time necessary to form the layers can be reduced, which is preferable in view of the productivity.

### (Method of Measuring Layer Thickness)

The measurement of the layer thickness of the surface layer which constitutes the intermediate transfer member according to the present invention is performed by a known thickness measurement method to measure the thickness of nanometer level, for example, an X-ray-reflectance measuring method (XRR: X-ray Reflection). In the thickness measurement by an X-ray-reflectance measuring method, the layer thickness is determined by measuring the interference signal of the reflected wave generated from the incident X ray entered in the film.

Namely, when the incident angle of X-ray into a thin film formed on a substrate is shallow, total reflection of the X-ray will occur, however, when the incident angle of the X-ray exceeds a certain value, the X-ray can enter the inside of the thin film.

The incident X-ray which entered into the thin film is divided into a transmitted wave and a reflected wave which has an interferential action at a specimen surface or at an interface.
In the X-ray-reflectance measuring method, the measurement is carried out while changing the incident angle of the X-ray to obtain the interference signal of the reflected wave accompanying the change of an optical path difference. The thickness of a thin film can be measured and calculated based on the analysis of the interference signal.

As a measuring device using such an X-ray-reflectance measuring method, for example, a micro-X-ray diffractometer MXP21 (produced by MAC Science Inc.) may be cited. A thickness measurement procedure of the surface layer which constitutes the intermediate transfer member according to the present invention using MXP21 (produced by MAC Science Inc.) will be described below.

As a target of the X-ray source, copper is employed, and operation is performed at 42 kV with 500 mA. A multi-layer film parabolic mirror is used as an incident monochrometer. A 0.05 mm×5 mm incident slit and a 0.03 mm×20 mm light receiving slit are employed. According to the 2θ/θ scanning technique, measurement is conducted at a step width of 0.005° in the range from 0 to 5°, 10 seconds for each step by the FT method. Curve fitting is applied to the reflectivity curve having been obtained, using the Reflectivity Analysis Program Ver. 1 of MAC Science Inc. Each parameter is obtained so that the residual sum of squares between the actually measured value and fitting curve will be minimized. From each parameter, the thickness of the laminated layer can be obtained.

### (Description for Intermediate Layer and Hard Layer)

Next, the intermediate layer and the hard layer which constitute the surface layer will be explained. As mentioned above, the surface layer which constitutes the intermediate transfer member of the present invention is constituted of at least an intermediate layer and a hard layer containing a metal oxide as a main component. A hard layer is a portion which forms the outermost surface of the intermediate transfer member of the present invention, on which a toner image formed on the photoreceptor is transferred and adhered, and then the adhered toner image is transferred onto a transfer material. The intermediate layer is provided between the elastic layer and the hard layer in order to prevent the hard layer from cracking or exfoliating from the elastic layer. The intermediate layer and the hard layer will be explained in detail below.

### (Intermediate Layer)

The intermediate layer of the present invention is provided between the elastic layer and the hard layer, and may be formed to have a one layer structure or a multi-layer structure containing two or more layers.

In the present invention, the layer density of the intermediate layer is smaller than the layer density (elastic modulus) of the hard layer. Further, the elastic modulus of the intermediate payer is preferably smaller than the elastic modulus of the hard layer. The layer density and the elastic modulus will be described in detail later.

Also, in the present invention, it is preferable that the intermediate layer has a multi-layer structure containing two or more layers, and it becomes possible to gradually increase the layer density or the elastic modulus of the intermediate layer toward the hard layer side from the elastic layer side, by forming the intermediate layer to have a multi-layer structure containing two or more layers, or an inclined structure. Here, the inclined structure means a structure in which the intermediate layer forming factor such as an atomic content of carbon in the intermediate layer continuously changes in the thickness direction of the intermediate layer. The inclined structure can be obtained by continuously changing the layer forming condition in the layer forming process.

The layer thickness of the intermediate layer may be 0.3 nm or more, and it is preferably 5 nm or more but 900 nm or less and more preferably 20 nm or more but 300 nm or less.

The intermediate layer preferably contains a metal oxide typically a silicon oxide compound, a carbon-containing metal oxide or amorphous carbon as a main component, or contains a mixture thereof as a main component. Also, it is preferable that carbon atoms are incorporated in the intermediate layer, and the content of carbon atoms is preferably 1 atomic % or more but 20 atomic % or less.

The method of forming the intermediate layer is not specifically limited, and, in addition to well known methods represented by a dip coating method, it is possible to use an atmospheric pressure plasma method which is conducted by forming two or more electric fields each having a different frequency to form a layer. When forming an intermediate layer by the atmospheric pressure plasma method, the carbon atom content, the layer density or the elastic modulus can be suitably adjusted by controlling the output power of the power source controlling the intensity of the electric field or the concentration of the supplied raw material, whereby an intermediate layer having a desired property can be formed.

### (Hard Layer)

The hard layer as mentioned in the present invention refers to the outermost surface of the intermediate layer, namely, the portion directly in contact with the toner image in order to transfer the toner image from the photoreceptor and to transfer the toner image to a transfer material. The hard layer is desired to have a mechanical strength by which toner filming is avoided and formation of cracks is prevented even when it is subjected to rubbing by the cleaning member, while a high transferring property can be kept for a long time.

The hard layer is a layer which has a metal oxide as a main component. Specific examples of a metal oxide include a silicon oxide, a silicon oxide nitride, a silicon nitride, a titanium oxide, a titanium oxide nitride, a titanium nitride and an aluminum oxide. Of these, a silicon oxide is preferable.

In the present invention, the hard layer may be constituted of one layer, or may be constituted of two or more layers. By forming the hard layer to have a multi-layer structure, it is possible to form a structure in which the layer density or the elastic modulus gradually increases from the intermediate layer side to the side of the hard layer when the toner image is transferred or retained.

The thickness of the hard layer may be 0.2 nm or more, and it is preferably 5 nm or more but 300 nm or less, and more preferably 10 nm or more but 200 nm or less.

### (Description of Layer Density and Elastic Modulus of Intermediate Layer and Hard Layer)

Next, the measuring method of layer density and elastic modulus constituting the surface layer of the intermediate transfer member of the present invention will be explained. As described above, the surface layer constituting the intermediate transfer member of the present invention is constituted of at least an intermediate layer and a hard layer containing a metal oxide as a main component, while the layer density of the hard layer is larger than the layer density of the intermediate layer. Also, the elastic modulus of the hard layer is preferably larger than the elastic modulus of the intermediate layer.

### (Measuring Method of Layer Density)

The measuring method of the layer density of the intermediate layer and the hard layer will be explained below. Here, the “layer density” means the mass per unit volume of the surface layer constituting the intermediate transfer member. The layer density of the surface layer (the intermediate layer and the hard layer) constituting the intermediate transfer member of the present invention can be calculated from a critical angle for total reflection obtained by the X-ray reflection (XRR) which has been explained in the aforementioned measuring method of the thickness of the surface layer. Here, the “critical angle for total reflection” means the critical incident angle at which irradiated X-ray shows total reflection, and, when the incident angle of X-ray becomes larger than the prescribed angle, X-ray entering into the specimen is observed.

Here, in the surface layer constituted of the intermediate layer and the hard layer, the layer density of the hard layer can be determine as it is, however, the layer density of the intermediate layer is determined after the hard layer is removed by, for example, grinding to expose the intermediate layer.

The outline of the X-ray reflection may be referred to, for example, the description in page 151 of “Handbook of X-ray diffraction” (edded by RIGAKU Corp., 2000, published by Kokusai Bunken Insatsu Co., Ltd.) or the description in KAGAKU KOGYO, 1999, No. 22.

In the present invention, the layer density of the hard layer is 2.07 g/cm³ or more but 2.19 g/cm³ or less, which is larger than the layer density of the intermediate layer. The layer density of the intermediate layer is preferably 1.40 g/cm³ or more but 2.10 g/cm³ or less.

A specific example of the measuring method of the layer density employed in the present invention will be shown below. In this method, a specimen having a flat surface is irradiated with X-ray with a very shallow angle. “MXP21” produced by MAC Science Inc. is used as a measuring apparatus. As a target of the X-ray source, copper is employed, and operation is performed at 42 kV with 500 mA. A multi-layer film parabolic mirror is used as an incident monochrometer. A 0.05 mm×5 mm incident slit and a 0.03 mm×20 mm light receiving slit are employed. According to the 2θ/θ scanning technique, measurement is conducted at a step width of 0.005° in the range from 0 to 5°, 10 seconds for each step by the FT method. Curve fitting is applied to the reflectivity curve having been obtained, using the Reflectivity Analysis Program Ver. 1 of MAC Science Inc. Each parameter is obtained so that the residual sum of squares between the actually measured value and fitting curve will be minimized. From each parameter, the thickness and the density of the laminated layer can be obtained. In the present invention, also the layer thickness can be obtained via above mentioned X-ray reflection.

### (Measuring Method of Elastic Modulus)

The measuring method of the elastic modulus of the intermediate layer and the hard layer constituting the surface layer of the intermediate transfer member will be explained.

The measurement of the elastic modulus of the surface layer constituting the intermediate member can be conducted employing a well known elastic modulus measuring method. For example, a method to apply a prescribed deformation with a prescribed frequency (Hz) using VIBRON DDV-2 produced by ORIENTECH Co., Ltd., a method to measure an elastic modulus using RSA-II (produced by RHEOMETRIC Co.), or a method to use nanoindenter from a measurement value obtained when a ceramic layer is formed on a transparent substrate and applied deformation on the ceramic layer is varied with a prescribed frequency, or a method to measure using nano indenter “NANO Indenter TMXP/DCM” produced by MST SYSTEM Corp.

Since the surface layer constituting the intermediate transfer member according to the present invention is an extremely thin layer having a thickness is of 0.5 nm or more but 1000 nm or less, a measurement via a nanoindentation method is preferably conducted in order to accurately determine the elastic modulus of such a thin film. The nanoindentation method is a method in which a specimen is subjected to continuous loading and de-loading using a minute load applying means which is called an indenter, such as a needle, to draw a load-displacement curve, and the elastic modulus and hardness of the specimen are calculated from the load-displacement curve. Since the elastic modulus and hardness determined by the nanoindentation method represent direct elastic modulus and hardness of the surface of the specimen, the elastic modulus and hardness determined by the nanoindentation method are suitable as indexes of the surface elastic modulus and surface hardness.

The elastic modulus as mentioned in the present invention means a ratio of the stress applied to the specimen and the deformation caused by the stress, and, accordingly, is expressed by the following equation,

G=σ/γ

provided that elastic modulus is expressed by G, stress is expressed by σ and deformation is expressed by γ. As understood from the above equation, a harder material exhibits a higher elastic modulus and a softer material exhibits a smaller elastic modulus.

The measuring method of the elastic modulus of the surface layer (the intermediate layer and hard layer) of the intermediate transfer member via the nanoindentation method.

As described above, the elastic modulus of the surface layer constituting the intermediate transfer member of the present invention, namely, the elastic moduli of the intermediate layer and the hard layer can be measured via a measuring method of an elastic modulus employing a nanoindentaion method. In concrete, the relationship between a load and an indented depth (displacement quantity) is measured to calculate a plastic deformation hardness from measured values, while pushing down an indenter into the thin layer (surface layer) using a minute diamond indenter.

Specifically in measurement of a thin film of 1 μm or less, this method is featured in that it is not susceptible to the physical property of a resin substrate and rarely causes cracking of thin film when being indented. Accordingly, this method is generally applied to physical property measurement of an extremely thin film.

Here, when the elastic moduli of hard layer and the intermediate layer are measured, the elastic modulus of the hard layer can be determine as it is, however, the elastic modulus of the intermediate layer is determined after the hard layer is removed by, for example, grinding to expose the intermediate layer employing the nanoindentation method.

The measuring method of the elastic modulus using a nanoindentation method will be specifically explained below using FIG. 2. FIG. 2 illustrates an example of a measurement device which is capable of measuring an elastic modulus using a nanoindentation method.

In FIG. 2, numeral 31 designates a transducer, numeral 32 designates a diamond Berkovich indenter having a regular-triangle top, numeral 170 designates an intermediate transfer member, numeral 175 designates a resin substrate, numeral 176 is an elastic layer and numeral 177 designates the surface layer.

This measurement apparatus enables measuring the displacement at an accuracy of nanometer by using the transducer 31 and the diamond Berkovich indenter having a regular-triangle top 32, while applying a load of a μN order. As an example of a commercially available measuring apparatus having a constitution shown in FIG. 2, for example, NANO Indenter XP/DCM (produced by MTS Systems Co./MST NANO Instruments Co.) may be cited.

The measuring condition of the elastic modulus of each layer constituting the surface layer of the intermediate transfer member using such as the above measuring apparatus is, for example, as follows.

### Measurement Condition:

Measurement device: NANO Indenter XP/DCM (produced by MTS Systems Co.),

Measurement indenter: diamond Berkovich indenter having a top form of regular triangle,

Measurement environment: 20° C., 60% RH,

Measurement sample: an intermediate transfer member being cut to a size of 5 cm×5 cm to prepare a measurement sample,

Maximum load setting: 25 μN,

Indenting rate: weighing is applied at a rate reaching a maximum load of 25 μN over 5 sec proportional to the time.

Each sample is measured randomly at 10 points and an average value thereof is defined as a hardness determined by the nanoindentation method.

### (Concentration of Carbon Atoms)

Next, the concentration of carbon atoms in the surface layer, namely, the intermediate layer and hard layer, which constitutes the intermediate transfer member according to the present invention, will be explained. In the present invention, the concentration of carbon atoms in the intermediate layer is preferably higher than the concentration of carbon atoms in the hard layer. The concentration of carbon atoms is expressed by atomic % of carbon, and the concentration of carbon atoms can be determines via a well-known analysis method. In the present invention, it is preferably determined calculated via an XPS method which will be explained later. The concentration of carbon atoms is defined as follows.

atomic % of carbon=(number of carbon atoms/number of total atoms)×100

An XPS method is also called an X-ray Photoelectron Spectroscopy, which is an analysis method for identification of element existing in a local surface of a specimen or identification of state of chemical bond.

In the present invention, a commercially available XPS surface analysis apparatus may be used. As a concrete apparatus, “ESCALAB-200R” produced by VG SCIENCETIC may be cited. In the Examples described later, the aforementioned apparatus was used.

The concrete condition in the case of measuring the carbon contents in the intermediate layer and the hard layer of the intermediate transfer member according to the present invention using the aforementioned apparatus was as follows. Magnesium (Mg) was used for the X-ray anode, and measurement was carried out at the power of 600 W (the acceleration voltage of 15 kV, and the emission current of 40 mA). The energy resolution was set to 1.5 eV-1.7 eV when measurement was carried out with a full width at half maximum of a clean Ag3d5/2 peak.

As a measurement, first, the range of binding energy of 0 eV-1100 eV was measured with a data incorporation interval of 1.0 eV to examine what kind of element is detected.

Next, data of detected etching ion species were incorporated for all the elements, and a narrow scan was conducted for a photoelectron peak which gave the maximum intensity with a interval of 0.2 eV to measure the spectrum of each element.

The obtained spectrum was sent to “COMMON DATA PROCESSING SYSYTEM” produced by VAMAS-JAPAN (Ver. 2.3 or subsequent ones is preferred), in order not to cause a difference in the results of carbon content calculation due to the difference in the measuring apparatus or computers, followed by processing the date with the software to obtain the content of each element of analysis target (carbon) in terms of atomic % of carbon.

Before conducting quantitative processing, calibration of Count Scale was performed with respect to carbon, and the smoothing treatment employing five points was carried out. In the quantitative processing, the peak area (cps*eV) in which the back ground was removed was used. The method of Shirley was used for background processing. D. A. Shirley, Phys. Rev. B5, 4709 (1972) can be referred to as for the Shirley method.

Next, the compressive stress which acts on the surface layer of the intermediate transfer member according to the present invention will be described. In the present invention, the compressive stress which acts on the surface layer of the intermediate transfer member is preferably 30 MPa or less. The “compressive stress” as used in the present invention is a value obtained by dividing the force produced when the surface of an intermediate transfer member is compressed perpendicularly by a unit area. The “compressive stress” acts perpendicularly to an intermediate transfer member surface, i.e., a surface layer, and does not act in the horizontal direction, i.e., the plane direction of a surface layer.

When the compressive stress of a surface layer is made to be 30 MPa or less in the intermediate transfer member according to the present invention, it is expected that the internal stress which acts on the surface layer becomes moderate where no large stress is applied on the surface layer, and, as a result, it contributes to prevent the occurrence cracks. Further, it is considered that it contributes to provide a hardness by which the toner image carried on the intermediate transfer member is uniformly transferred without unevenness on a transfer material.

### (Measurement of Compressive Stress)

The compressive stress described in the present invention can be calculated by using any measuring apparatus as far as it is a commercially available measuring device which is capable of measuring a compressive stress. As a concrete measuring apparatus, for example, measuring apparatus for physical-properties of films “MH4000” produced by NEC SANEI Co., Ltd. may be cited as a typical example.

When measuring the compressive stress of the surface layer of the intermediate transfer member using aforementioned measuring apparatus for physical-properties of films “MH4000”, specifically, the compressive stress (residual stress, MPa) can be measured by forming each layer of a thickness of 1 μm on a quart glass having a thickness of 100 μm, a width of 10 mm and a length of 50 mm using the above apparatus.

Next, the resin substrate and elastic layer constituting the intermediate transfer member according to the present invention, and the preparation method thereof will be explained. The method of forming a surface layer will be mentioned later.

<Resin Substrate and Preparation Method thereof>

A resin substrate constituting the intermediate transfer member according to the present invention exhibits a rigidity which avoids deformation of the intermediate transfer member, caused by a load which is applied from a cleaning blade which is a cleaning member to the intermediate transfer member. Namely, the resin substrate works to reduce the influence of an external force when applied to the intermediate transfer member onto the transfer property due to its rigidity. The resin substrate constituting the intermediate transfer member according to the present invention is preferably formed by using a material exhibiting an elastic modulus of 1.5 to 15.0 GPa, determined by a nanoindentation method.

Examples of a material achieving such performance include resin materials such as a polycarbonate, poly(phenylene sulfide), polyfluorovinylidene, polyimide, polyether and polyetherketone. Of these, a polyimide, polycarbonate and poly(phenylene sulfide) is preferred.

A resin substrate prepared by adding an electrically conductive material to an aforementioned resin material so that the electrical resistance (volume resistivity) is, for example, 10⁵ to 10¹¹ Ω·cm may also be used. The thickness of the resin substrate is preferably 50-200 μm. As the shape of the resin substrate, in addition to the seamless belt shape as used in the intermediate transfer member, a drum shape may also be cited. A resin substrate which can have a drum shape is preferable in view of obtaining a mechanical strength.

As an electrically conductive material to be added to a resin material described above, a carbon black may be cited. A neutral or acidic carbon black is preferably used. The addition amount of an electrically conductive material in the resin material depends on its kind but it is preferably added in such an amount that the electrical resistivity (volume resistivity) of the intermediate transfer member falls within the aforementioned range, and, specifically, the addition amount is preferably 10-20 parts by mass, and more preferably 10-16 parts by mass per 100 parts of resin material.

The aforementioned resin substrate can be manufactured by a well-known general method. For example, it can be manufactured by melting a material in which aforementioned electrically conducive is mixed in the aforementioned resin material, and by extruding the melt from a T-die or a ring-die, followed by quenching.

Further, the surface of the aforemention resin substrate may be subjected to a surface treatment, for example, a corona-treatment, a flame treatment, a plasma treatment, a glow discharge treatment, a surface roughening treatment and a chemical treatment.

<Elastic Layer and Preparation Method thereof>

The elastic layer which constitutes the intermediate transfer member according to the present invention enables to transfer a toner image on a photoreceptor uniformly to the intermediate transfer member without unevenness by providing a certain extent of elasticity to the intermediate transfer member. Namely, the intermediate transfer member is made to avoid an image defect so called lack of text image by causing deformation of the elastic layer due to the pushing pressure from the photoreceptor in the primary transfer process, whereby the concentration of the pressure onto the toner image is reduced.

The elastic layer which constitutes the intermediate transfer member according to the present invention can be formed by employing an elastic material called a rubber or an elastomer. Examples of an elastic material include styrene butadiene rubber, high styrene rubber, butadiene rubber, isoprene rubber, ethylene-propylene copolymer rubber, nitrile-butadiene rubber, chloroprene rubber, butyl rubber, silicone rubber, fluororubber, nitrile rubber, urethane rubber, acrylic rubber, epichlorohydrin rubber and norbomane rubber, which may be used singly or as a mixture.

The hardness of the hard layer is preferably 40-80 in terms of JIS A hardness, and the thickness of the elastic layer is preferably 100 μm-500 μm.

The elastic layer constituting the intermediate transfer member according to the present invention may be prepared by dispersing an electrically conductive material in the aforementioned elastic material so that an electrical resistance (volume resistivity) is 10⁵ to 10¹¹ Ω·cm.

Examples of such a conductive substance to be added to an elastic layer include carbon black, zinc oxide, tin oxide and silicon carbide. When a carbon black is used, a neutral or acidic carbon black is preferably used. The addition amount of an electrically conductive material in the elastic material depends on its kind but it is preferably added in such an amount that the electrical resistance (volume resistivity) of the elastic falls within the aforementioned range, and, specifically, the addition amount is preferably 10-20 parts by mass, and more preferably 10-16 parts by mass per 100 parts of resin material.

The elastic layer may be prepared according to the following procedures. The aforementioned resin substrate is immersed standing upright into a bath housing a coating solution for an elastic layer. After repeating immersion a few times to form coating of a prescribed thickness, the resin substrate is pulled up from the bath. Then, after dried to remove solvent, the resin substrate is subjected to a heating treatment (for example, at 6-150° C. for 60 min.) to form an elastic layer.

### (Anchor Coat Agent Layer)

In the intermediate transfer member according to the present invention, in order to increase the adhesion between the aforementioned elastic layer and the resin substrate, an anchor coat agent layer may be formed between them. Examples of an anchor coat agent used for such an anchor coat agent layer include a polyester resin, an isocyanate resin, a urethane resin, a polyacrylic resin, an poly(ethylene vinyl alcohol) resin, a modified vinyl resin, an epoxy resin, a modified styrene resin, a modified silicone resin and an alkyl titanate, which are used singly or in combination of two or more kinds thereof. An anchor coat agent may be added together with an additive known in the art.

The foregoing anchor coat agent is coated on a resin substrate by a commonly known method, such as roll coating, gravure coating, knife coating, dip coating and spray coating, and anchor coating is performed, after applying a coating liquid for the anchor coat agent layer, by removing a solvent, diluent or the like is by drying or by subjecting to UV hardening. The coating amount of the foregoing anchor coating agent is preferably 0.1 to 5 g/m² (in dried state).

Next, the preparation method of the surface layer constituting the intermediate transfer member according to the present invention will be explained using concrete examples. The preparation method of the surface layer constituting the intermediate transfer member according to the present invention is not specifically limited, and it can be prepared according to the methods, for example, dry processes such as a vacuum deposition method, a molecular beam epitaxy growing method, a sputtering method and an atmospheric plasma CVD method; and wet processes including coating methods such as a spray coat method, a blade coat method, a dip coat method and a cast method and patterning methods such as a printing method and an inkjet method.

Among these methods, preferable is to prepare a thin film of the surface layer via an atmospheric pressure plasma CVD method containing the steps of supplying a gas containing a thin film forming gas into a discharge space formed between opposing electrodes at atmospheric pressure or approximately atmospheric pressure; generating a high frequency electric field in the discharge space to excite the gas; and exposing a substrate to the excited gas.

This atmospheric pressure plasma CVD method does not need a reduced pressure chamber, and enables a high rate film formation, thus it provides a film forming method of a high productivity. Further, the atmospheric pressure plasma CVD method provides a homogeneous film exhibiting a high surface flatness, and enables to relatively easily form a film having considerably small internal stress.

Recently, in the field of an electrophotographic image formation apparatus, desired is toner image formation providing an image quality exhibiting color reproduction faithful to an original image and excellent thin-line reproduction employing techniques of digital treatment or reduction of toner diamer. Also, for the intermediate transfer member, it is desired to accurately transfer a toner image onto a transfer material such as a paper sheet without spoiling the image quality of the toner image formed on the photoreceptor, and high surface flatness is also desired. As described above, according to the atmospheric pressure plasma CVD method, it is possible to form a homogeneous thin film exhibiting excellent flatness. Accordingly, the present inventors have considered that the atmospheric pressure plasma CVD method is a promising method to form a surface layer of an intermediate transfer member, and, after intensive studies, the present inventors have found that it is possible to prepare a intermediate transfer member having the aforementioned effect via an atmospheric pressure plasma CVD method.

Thus, as one of the typical methods to form a surface layer (an intermediate layer and a hard layer) constituting the intermediate transfer member according to the present invention, an atmospheric pressure plasma CVD method by which a thin film of the surface layer is formed by generating an electric field under an atmospheric pressure or vicinity thereof can be cited.

Hereafter, the apparatus formed with an atmospheric pressure plasma CVD method, a method, and the gas to be used will be described.

“The atmospheric pressure plasma CVD (Chemical Vapor Deposition; chemical vapor deposition) method (hereafter, referred to as an atmospheric pressure plasma method)” as used in the present invention means a treatment method in which a discharge gas is excited and discharged under an atmospheric pressure or vicinity thereof, a raw material gas or a reaction gas is introduced to the discharge space to excite the gas, exposing a substrate to the excited raw material gas or reaction gas to form a thin film.

This method has been described, for example, in JP-A Nos. 11-133205, 2000-185362, 11-61406, 2000-147209 and 2000-121804. According to the atmospheric pressure plasma method, highly functional thin films can be formed with a high productivity.

“The atmospheric pressure or vicinity thereof” means a pressure of 20 kPa-110 kPa, and preferably 93 kPa-104 kPa.

FIG. 4 is a schematic view showing a first production apparatus to produce a surface layer of the intermediate transfer member.

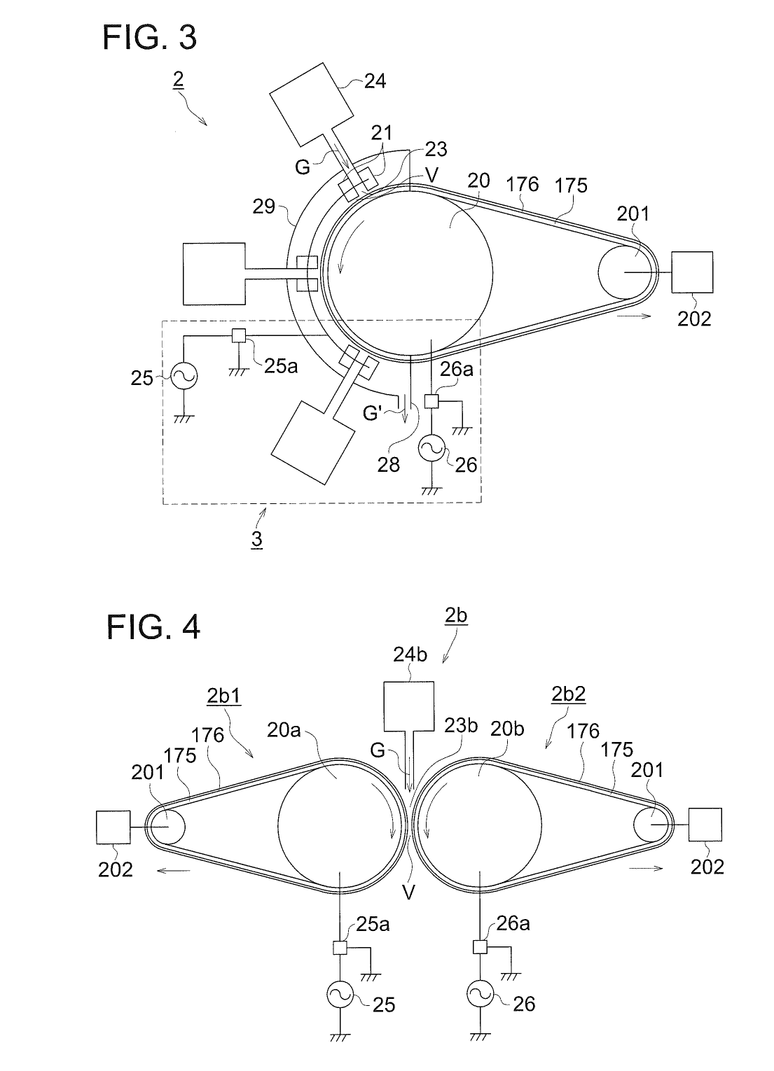

In FIG. 3, a first production apparatus of an intermediate transfer member (a direct system in which the discharge space is almost the same as the thin-layer deposition area) is one which forms a surface layer formed on an elastic layer 176 formed on a resin substrate 175 and is comprised of a roll electrode 20 and a driving roller 201 entraining the resin substrate 175 of a seamless belt-form intermediate transfer member 170 and rotating in the direction indicated by the arrow, and an atmospheric plasma CVD apparatus 3 as a thin-layer forming apparatus to form a surface layer on the elastic layer 176.

The atmospheric plasma CVD apparatus 3 is provided with at least one set of fixed electrodes 21 disposed along the circumference of the roll electrode 20, a discharge space 23 in which the fixed electrodes 21 opposes the roll electrode 20 and discharging is performed, a mixed gas supplying device 24 to form a mixed gas G of raw material gas and discharge gas and supply the mixed gas G to a discharge space 23, a discharge vessel 29 to reduce inflow of air into the discharge space 23, a first power source 25 connected to the roll electrode 20, a second power source 26 connected to the fixed electrode 21, and an exhaust section 28 to exhaust an exhaust gas G′.

The mixed gas supplying device 24 supplies a raw material gas to form a layer selected from an inorganic oxide layer and an inorganic nitride layer and a gas mixture including nitrogen gas or argon gas to the discharge space 23. It is preferred to mix oxygen gas or hydrogen gas to accelerate the reaction through oxidation-reduction reaction.

The driving roller 201 is energized by a tension-energizing means 202 in the direction indicated by the arrow and applies a prescribed tension to a substrate 175. The tension-energizing means 202 releases application of tension when replacing the substrate 175, rendering easy replacement of the substrate 175.

A first power source 25 outputs a voltage of frequency ω1 and a second power source 26 outputs a voltage of frequency ω2 and these voltages generate electric field V formed by overlapping frequencies ω1 and ω2 in the discharge space 23. The discharge gas G is energized to form a plasma state by the electric field V and a thin-layer corresponding to a raw material gas contained in the mixed gas G (intermediate layer, hard layer) is deposited on the surface of the elastic layer 176.

Alternatively, a surface layer may be stacked by plural fixed electrodes located downstream in the rotational direction of a roll electrode and a mixed gas supplying device, whereby the thickness of the surface layer is controlled.

The surface layer may be deposited by a fixed electrode located and a mixed gas supplying device most downstream in the rotational direction of the electrode among plural fixed electrodes, while another layer, for example, an adhesion layer to enhance adhesion of the surface layer 177 and the elastic layer 176 is formed by another fixed electrode and mixed gas supplying device located upstream.

Further, to achieve enhanced adhesion of the surface layer 177 to the elastic layer 176, a gas supplying device to supply a gases such as argon or oxygen and a fixed electrode may be provided upstream from a fixed electrode and a mixed gas supplying device to supply gas such as argon or oxygen to perform plasma treatment, thereby activating the surface of the elastic layer 176.

As described above, the intermediate transfer member 1 is entrained about paired rollers, one of the paired rollers is one electrode of paired electrodes, at least one fixed electrode of the other electrode is provided along the outer circumference of a roller of said one electrode, an electric field is induced between electrodes under atmospheric pressure to perform plasma discharging to deposit a thin layer on the surface of the intermediate transfer member, rendering it feasible to produce an intermediate transfer member exhibiting enhanced transferability and superior cleaning property and improved durability.

FIG. 4 illustrates a second production apparatus to produce a surface layer of an intermediate transfer member.

A second production apparatus 2b of an intermediate transfer member simultaneously forms a surface layer on an elastic layer provided on plural resin substrates, and is mainly constituted of film forming devices 2b1 and 2b2 to form a surface layer on an elastic layer.

The second production apparatus 2b (which is a deformed direct system and performs discharging and thin-layer deposition between opposed roll electrodes) is provided with a first film forming device 2b1, a second film forming device 2b2 which is almost symmetrically arranged with 2b1 at a prescribed distance from 2b1, and a mixed gas supplying device 24b which is disposed between the first film forming device 2b1 and the second film forming device 2b2, forms a gas mixture G of at least a raw material gas and a discharge gas and supplies the gas mixture to a discharge space 23b.

The first film forming device 2b1 is provided with a roll electrode 20a entraining a seamless form resin substrate 175 of an intermediate transfer member and rotating in the direction indicated by an arrow, a driven roller 201, a tension-energizing means 202 to energize the driven roller 201 and a fist power source 25 connected to the roll electrode 20a; the second film forming device 2b2 is provided with a roll electrode 20b entraining a seamless form substrate 175 of an intermediate transfer member and rotating in the direction indicated by the arrow, a driven roller 201, a tension-energizing means 202 to energize the driven roller 201 and a second power source 26 connected to the roll electrode 20b.

Further, the second production apparatus 2b is provided with a discharge space 23b in which discharging is performed in the opposing area of the roll electrode 20a and the roll electrode 20b.

The mixed gas supplying device 24b supplies a raw material gas to form at least one layer selected from an inorganic oxide layer and an inorganic nitride layer and a gas mixture containing a rare gas such as nitrogen gas or argon to the discharge space 23b. It is preferred to mix oxygen gas or hydrogen gas to accelerate reaction through oxidation-reduction reaction.

A first power source 25 outputs a voltage of frequency ω1 and second power source 26 outputs a voltage of frequency ω2, and these voltages generate an electric field V formed by overlapping frequencies ω1 and ω2 in the discharge space 23b. Then, the mixed gas is made to a plasma state (or excited). The mixed gas which has been made to a plasma state (or excited) is exposed to the surfaces of the elastic layer 176 of the first film forming device 2b1 and the elastic layer 176 of the second film forming device 2b2, and a layer (intermediate layer, hard layer) corresponding to a raw material gas contained in the mixed gas which has been made to a plasma state (or excited), is simultaneously deposited and formed on the surface of the elastic layer 176 of the first film forming device 2b1 and on the surface of the elastic layer 176 of the second film forming device 2b2.

Herein, opposed roll electrode 20a and roll electrode 20b are disposed separately at a prescribed distance.

In the following, there is described an atmospheric plasma CVD apparatus to form a surface layer on the elastic layer 176.

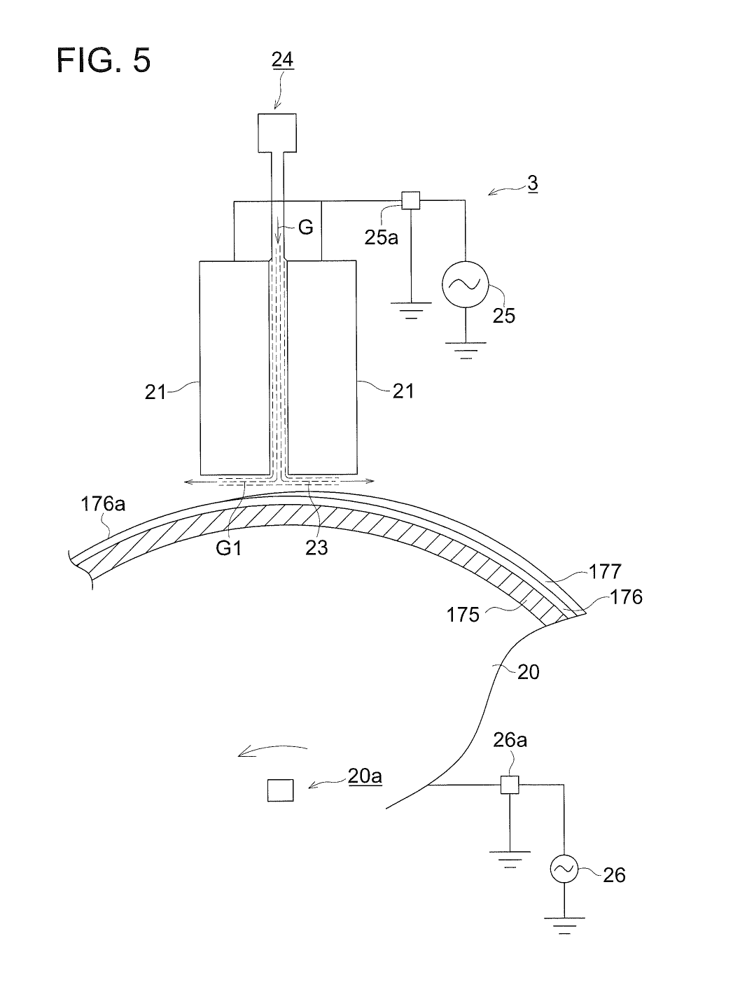

FIG. 5 is an abstraction of the thin-layer forming region of the broken line portion in FIG. 3.

FIG. 5 illustrates a first plasma film-forming apparatus to produce a surface layer 177 of an intermediate transfer member through plasma.

There will be described an example of a suitable atmospheric plasma CVD apparatus used for formation of the surface layer 177 with reference to FIG. 5.

An atmospheric plasma CVD apparatus 3 is a production apparatus of an intermediate transfer member, which is provided with at least one pair of rollers which detachably entrains the substrate and rotatably drives it and at least one pair of electrodes performing plasma discharge, wherein one electrode of the pair of electrodes is a roller of the pair of rollers and the other electrode is a fixed electrode opposed to the foregoing roller via the resin substrate, and the elastic layer is exposed to plasma generated in the opposing area of the roller and the fixed electrodes to deposit and form the foregoing surface layer. When using nitrogen as a discharge gas, for example, application of a high voltage to one power source and application of a high-frequency to the other power source stably initiate discharge and continue the discharge, rendering it feasible to suitably employ the apparatus.

As described above, the atmospheric plasma CVD apparatus 3 is provided with a mixed gas supplying device 24, a fixed electrode 21, a first power source 25, a first filter 25a, a roll electrode 20, a driving means 20a to rotatably drive the roll electrode in the direction indicated by the arrow, a second power source 26 and a second filter 26a, and plasma discharging is performed in a discharge space 23 to excite a gas mixture G composed of a raw material gas and a discharge gas, while the elastic layer surface 176a is exposed to thus excited gas mixture G1 to deposit and form the surface layer 177 on the surface.

A first high-frequency voltage of frequency ω1 is applied to the fixed electrode 21 from the first power source 25 and a second high-frequency voltage of frequency ω2 is applied to the roll electrode 20 from the second power source 26, whereby an electric field overlapping the frequency ω1 at an electric field intensity V1 and the frequency ω2 at an electric field intensity V2 is generated between the fixed electrode 21 and the roll electrode 20, a current I1 is sent through the fixed electrode 21 and a current I2 is sent through the roll electrode 20, generating plasma between electrodes.

Herein, the relationship of the frequency ω1 and the frequency ω2, and the relationship of the electric field intensity V1, the electric field intensity V2 and an electric field strength IV satisfy:

V1≧IV>V2 or V1>IV≧V2 at ω1<ω2

and an output density of the second high-frequency electric field becomes not less than 1 W/cm².

The electric field intensity IV initiating discharge of nitrogen gas is 3.7 kV/mm, so that the electric field V1 applied from the first power source 25 is preferably 3.7 kV/mm or more, and the electric field V2 applied from the second high-frequency power source 60 is preferably 3.7 kV/mm or less.

Examples of the first power source 25 (high-frequency power source), which is applicable to the first atmospheric plasma CVD apparatus 3 include the commercially available ones described following Table 1, any one of which is usable.

TABLE 1

| Applied Power | | | | |
|---|---|---|---|---|
| Symbol | Maker | Frequency | | Product Name |
| A1 | Shinko Denki | 3 | kHz | SPG3-4500 |
| A2 | Shinko Denki | 5 | kHz | SPG5-4500 |
| A3 | Kasuga Denki | 15 | kHz | AGI-023 |
| A4 | Shinko Denki | 50 | kHz | SPG50-4500 |
| A5 | Haiden Laboratory | 100 | KHz* | PHF-6k |
| A6 | Pearl Kogyo | 200 | kHz | CF-2000-200k |
| A7 | Pearl Kogyo | 400 | kHz | CF-2000-400k |
| A8 | SEREN IPS | 100-460 | kHz | L3001 |

Examples of the second power source 26 (high-frequency power source) include the commercially available ones described following Table 2, namely.

TABLE 2

| Applied Power | | | | |
|---|---|---|---|---|
| Symbol | Maker | Frequency | | Product Name |
| B1 | Pearl Kogyo | 800 | kHz | CF-2000-800k |
| B2 | Pearl Kogyo | 2 | MHz | CF-2000-2M |
| B3 | Pearl Kogyo | 13.56 | MHz | CF-5000-13M |
| B4 | Pearl Kogyo | 27 | MHz | CF-2000-27M |
| B5 | Pearl Kogyo | 150 | MHz | CF-2000-150M |

| | | | |
|---|---|---|---|
| B6 | Pearl Kogyo | 20 MHz-99.9 MHz | RP-2000-20/100M |

Of the foregoing power sources, the asterisk mark (*) indicates Haiden Res. Lab. Impulse high-frequency power source (100 kHz in the continuous mode). Otherwise, they are a high-frequency power source applicable only by a continuous sine wave.

As the electric power supplied to opposed electrodes from the first and second power sources, a power (output density) of 1 W/cm² is supplied to the fixed electrode 21 to excite the discharge gas to a plasma state, thereby forming a thin-layer. The upper limit of power supplied to the fixed electrode 21 is preferably 50 W/cm² and is more preferably 20 W/cm², while the lower limit is preferably 1.2 W/cm². A discharge area (cm²) refers to an area of the region causing discharge in the electrode.

Supplying power (output density) at 1 W/cm² or more also to the roll electrode 20 results in enhanced output density, while maintaining uniformity of the electric high-frequency field. Thereby, a further uniform, high-density plasma can be formed, achieving compatibility of enhanced film-forming speed and enhanced film quality. The upper limit of power supplied to the roll electrode 20 is preferably 50 W/cm².

Herein, the waveform of a high-frequency electric field is not specifically limited and includes, for example, a continuous oscillation mode of a continuous sine wave form, called continuous oscillation mode and an intermittent oscillation mode intermittently performed on-off, called intermittent oscillation mode. Either one can be adopted but a high-frequency wave supplied to at least roll electrode 20 is preferably a continuous sine wave, whereby formation of a dense and high quality thin-layer is achieved.

Further, the first filter 25a is provided between the fixed electrode 21 and the first power source 25, thereby causing an electric current to flow from the first power source 25 to the fixed electrode 21 to be easily passed, and an electric current from the second power source 26 is grounded, thereby making it difficult to cause a current from the second power source 26 to the first power source 25 to pass; the second filter 26a is provided between the roll electrode 20 and the second power source 26, thereby causing an electric current from the second power source 26 to the roll electrode 20 to easily pass, and an electric current from the first power source 21 is grounded, thereby making it difficult to cause current from the first power source 25 to the second power source 26 to pass.

It is preferred to employ an electrode capable of maintaining a uniform and stable discharge state upon application of a strong electric field to the electrode. The electrode surface of at least one of the fixed electrode 21 and the roll electrode 20 is covered with a dielectric described below to be resistant to a strong electric field.

In the foregoing relationship of an electrode and a power source, the fixed electrode 21 and the roll electrode 20 may be connected to the second power source 26 and the first power source 25, respectively.

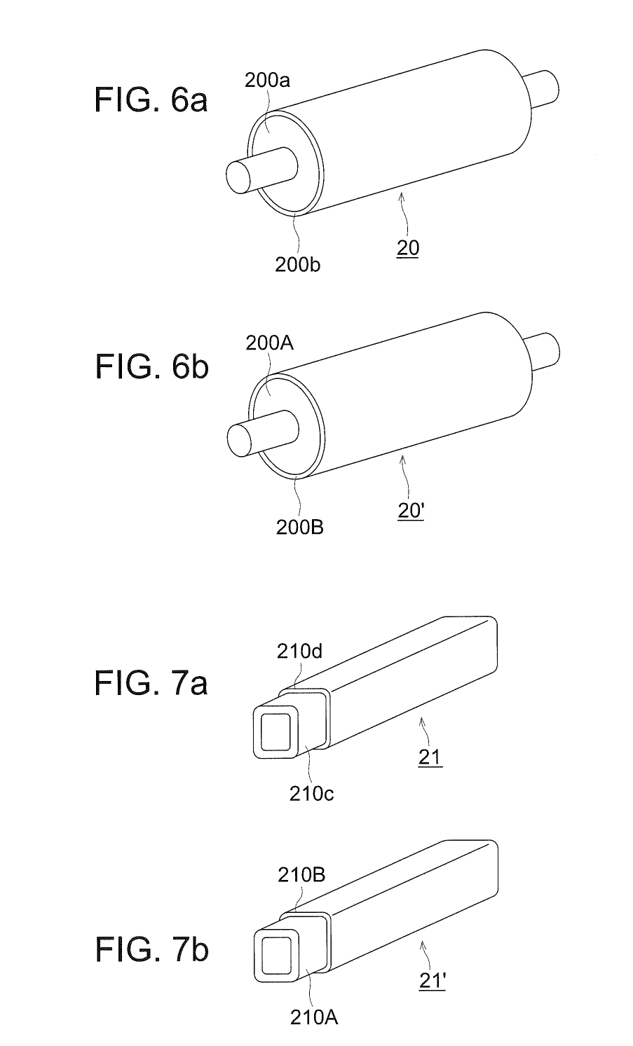

FIG. 6 is a perspective view showing an example of a roll electrode.

There will be described the constitution of the roll electrode 20. As shown in FIG. 6a, a roll electrode 20 is comprised of an electrically conductive base material 200a, such as a metal (hereinafter, denoted also as an electrode base material), which is thermally sprayed with a ceramic and then covered with a ceramic-covered dielectric 200b having been subjected to a hole-sealing treatment (hereinafter, also denoted simply as a dielectric). Preferred ceramic materials for use in such thermal-spraying include, for example, alumina and silicon nitride and of these, alumina is more preferred in terms of easier processability.

As shown in FIG. 6b, a roll electrode 20′ may be comprised of an electrically conductive base material 200A such as a metal, which is covered with a lining-treated dielectric 200B having been provided with an inorganic material lining. There are preferably used lining materials such as a silicate glass, a borate glass, a phosphate glass, a germanate glass, a tellurite glass, an aluminate glass and a vanadate glass. Of these, a borate glass is more preferred in terms of easy processability.

Examples of the conductive base material 200a or 200A include silver, platinum, stainless steel, aluminum and iron, and of these, stainless steel is preferred in terms of easier processability.

In one of the embodiments of the invention, a base material used for a roll electrode 200a or 200A employs a stainless steel jacket roll base material incorporating a cooling means (not shown in the drawing).

FIG. 7 is a perspective view showing an example of a fixed electrode.

In FIG. 7a, fixed electrodes 21, 21a and 21b of a square pillar or square barrel pillar is comprised of an electrically conductive base material 210c, such as a metal, which is thermally sprayed with a ceramic and then covered with a ceramic-covered dielectric 210d having been subjected to a hole sealing treatment, similarly to the roll electrode 20. Further, as shown in FIG. 7b, a fixed electrode 21′ of a square pillar or square banrrel pillar may be comprised of an electrically conductive base material 210A such as a metal, which is covered with a lining-treated dielectric 210B having been provided with an inorganic material lining.

In the following, there will be described an example of a film-forming step in the process of producing an intermediate member, comprising depositing the surface layer 177 on the elastic layer 176 formed on the on the resin substrate 175, with reference to FIGS. 3 and 5.

In FIGS. 3 and 5, after the substrate 175 is entrained about the roll electrode 20 and the driven roller 201, a prescribed tension is applied to the substrate 175 by the action of the tension-energizing means 202 and subsequently, the roll electrode 20 is rotatably driven at a prescribed rotation speed.

The mixed gas G which is formed from the mixed gas supplying device 24 is released into the discharge space 23.

A voltage of frequency ω1 is outputted from a first power source 25 and applied to a fixed electrode 21, and then, a voltage of frequency ω2 is outputted from a second power source 26 and applied to a roll electrode 20 and frequencies col and ω2 are superimposed to the discharge space by these voltages to generate an electric space.

The mixed gas G which has been released to the discharge space 23 is excited to a plasma state by the electric field V. Then, the surface of the elastic layer is exposed to the mixed gas G, being in a plasma state, whereby a raw material gas contained in the mixed gas G forms at least one layer selected from an inorganic oxide layer, an inorganic nitride layer and an inorganic carbide layer, that is, surface layer 177 on the elastic layer 176.

The discharge gas refers to a gas which has been excited to a plasma state by the foregoing conditions and including, for example, nitrogen, argon, helium, neon, krypton, xenon and mixtures thereof. Of these gases, nitrogen, helium and argon are preferred and nitrogen is cheap and preferable.

### (Raw Material Gas)

Raw material gas to form a surface layer employs organic metal compounds which are gas or liquid at ordinary temperature, specifically, an alkyl metal compound, a metal alkoxide compound or an organic metal complex compound. The phase state of these raw materials is not necessarily a gas phase at ordinary temperature and ordinary pressure, and either liquid phase or solid phase is usable if it can be gasified via melting, distillation or sublimation.

A raw material gas contains a component which becomes a plasma state in a discharge space to form a thin-layer, and examples thereof include an organic metal compound, an organic compound and an inorganic compound.

Example of a silicone compound include silane, tetramethoxysilane, tetraethoxysilane (TEOS), tetra-n-propoxysilane, tetraisopropoxysilane, tetra-n-butoxysilane, tetra-t-butoxysilane, dimethyldimethoxysilane, dimethyldiethoxysilane, diethyldimethoxysilane, diphenyldimethoxysilane, methyltrimethoxysilane, ethyltrimethoxysilane, phenyltrimethoxysilane, (3,3,3-trifluoropropyl)trimethoxysilane, hexamethyldisilane, bis(dimethylamino)dimethylsilane, bis(dimethylamino)methylvinylsilane, bis(ethylamino)dimethylsilane, N,O-bis(trimethylsily)acetoamide, bis(trimethylsilyl)carbodiimide, diethylaminotrimethylsilane, dimethylaminodimethylsilane, hexamethyldisilane, hexamethylcyclotrisilazane, nonamethyltrosilazane, octamethylcyclotetrasilazane, tetrakisdimethylaminosilane, tetraisocyanatosilane, tetramethyldisilane, tris(dimethylamino)silane, triethoxyfluorosilane, allyldimethylsilane, allylytimethylsilane, benzyltrimethylsilane, bis(trimethylslyl)acetylene, 1,4-bisbistrimethylsilyl-1,3-butadiene, di0t-butylsilane, 1,3-disilabutane, bis(trimethylsilyl)methane, cyclopentadienyltrimethylsilane, phenyldimethylsilane, phenytrimethylasilane, propargyltrimethylsilane, tetramethylsilane, trimethylsilylacetylene, 1-(trimethylsilyl)-1-propyne, tris(trimethylsilyl)methane, tris(trimethylsilyl)silane, vinyltrimethylsilane, hexamethyldisilane, octamethylcyclotetrasiloxane, tetramethylcyclotetrasiloxane, hexamethykyclotetrasiloxane, and M silicate 51, but are not limited to these.

Titanium compounds include, for example, an organic metal compound such as tetramethylaminotitanium; a metal hydride compound such as titanium monohydride or titanium dihydride; a metal halide compound such as titanium dichloride, titanium trichloride or titanium tetrachloride; and a metal alkoxide such as tetraethoxytitanium, tetraisopropoxytitanium or tetrabutoxytitanium, but are not limited to these.

Examples of an aluminum compound include aluminum n-butoxide, aluminum s-butoxide, aluminum t-butoxide, aluminum diisopropxide ethyl acetoacetate, aluminum ethoxide, aluminum hexafluoropentanedionate, aluminum isoproxide, aluminum(III) 2,4-pentanedionate and dimethylaluminum chloride, but are also not limited to these.

These raw materials may be used singly or a mixture of at least two components may be used.

### (Additive Gas)

When forming the surface layer of the intermediate transfer member according to the present invention, additive gas can be used in order to control the composition at the time of film forming, the elastic modulus, and the layer density.

Oxygen, hydrogen, and carbon dioxide gas can be cited as additive gas. For example, if hydrogen is used as an additive gas, it will be easy to form carbon-containing layer, and if oxygen is used, it will become easy to form a metal oxide film.

The elastic modulus of a surface layer can be adjusted by a film forming rate, the kind of a source gas or an additive gas to be used or a quantitative ratio of each gas.

In addition, the intermediate layer containing carbon atoms in the layer can be obtained by plasma exciting a mixed gas (a discharge gas) between a pair of electrodes (the roll electrode 20 and the fixed electrode 21) to radicalize a raw material gas containing carbon existing in the plasma, and exposing the surface of the elastic layer 176 to the plasma in aforementioned atmospheric pressure plasma CVD apparatus 3, whereby the organic molecules containing carbon or radicals containing carbon are incorporated in the intermediate layer.

A raw material gas to form an amorphous carbon layer (a layer containing amorphous carbon as a main component) can employ organic compound gas which is gas or liquid at ordinary temperature, specifically, hydrocarbon gas. The phase state of these raw materials is not necessarily a gas phase at ordinary temperature and ordinary pressure, and either liquid phase or solid phase is usable if it can be gasified via melting, distillation or sublimation by heating or depressurizing in the mixed gas supplying device 24. Examples of a hydrocarbon gas as a raw material gas at least include every kind of hydrocarbon gases containing a paraffinic hydrocarbon such as CH₄, C₂H₆, C₃H₈ and C₄H₁₀; an acetylenic hydrocarbon such as C₂H₂ and C₂H₄; an olefmic hydrocarbon, diolefinic hydrocarbon or an aromatic hydrocarbon. In addition to hydrocarbon, compounds at least containing carbon atom are usable, for example, alcohols, ketones, ethers, esters, CO, CO₂ and the like.

These raw materials may be used singly or in combination of two or more.

Next, there are described an image forming method and an image forming apparatus, each using the intermediate transfer member of the present invention.

### <<Image Forming Method and Image Forming Apparatus>>

The intermediate transfer member of the present invention is suitably applicable to electrophotographic image forming apparatuses, such as a copier, a printer, facsimile and the like.

An image forming apparatus in which an intermediate transfer member of the invention can be used will be described with reference to an example of a color image forming apparatus.

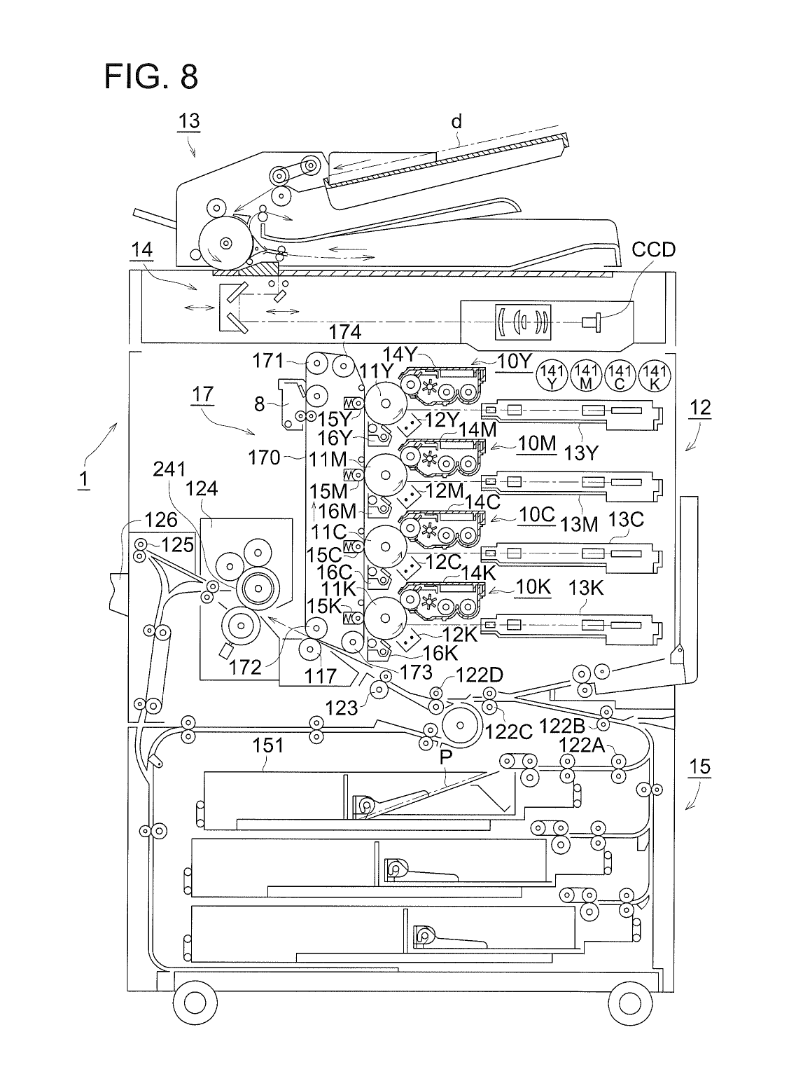

FIG. 8 is a sectional view showing an example of constitution of a color image forming apparatus.

This color image forming apparatus 10 is called a tandem type full-color copier, which is comprised mainly of an automatic document feeder 13, an original image reader 14, plural exposure means 13Y, 13M, 13C and 13K, plural sets of image forming sections 10Y, 10M, 10C and 10K, an intermediate transfer member 17, a paper feeder 15 and a fixing means 124.

On the upper portion of a main body 12 of the color image forming apparatus, the automatic document feeder 13 and the original image reader 14 are disposed. An image of a document d conveyed by the automatic document feeder 13 is reflected and image-formed through an optical system of the original image reader 14 and read by a line image sensor CCD.

Analog signals to which an original image read by the line image sensor CCD has been photoelectric-converted, are subjected to an analog treatment, an A/D conversion, shading correction and an image compression treatment in an image processing section (not shown in the drawing), and then transmitted to exposure means 13Y, 13M, 13C and 13K as digital data for the respective colors and latent images of the respective color image data are formed on each of drum-form photoreceptors 11Y,11M, 11C and 11K as a first image carrier via exposure means 13Y, 13M, 13C and 13K.

The image forming sections 10Y, 10M, 10C and 10K are tandemly disposed in the vertical direction and an intermediate transfer member 170 of the invention (hereafter, also referred to as an intermediate transfer belt), as a semi-conductive, endless belt-formed, and second image carrier, is disposed to the left side of photoreceptors 11Y, 11M, 11C and 11K, while being rotatably entrained about rollers 171, 172, 173 and 174.

The intermediate transfer belt 170 is driven in the direction indicated by the arrow through the roller 171 by a driving device (not shown in the drawing).

The yellow image forming section 10Y is provided with an electric-charging means 12Y, an exposure means 13Y, a developing means 14Y, a primary transfer roller 15Y as a primary transfer means and a cleaning means 16Y which are disposed around the photoreceptor 11Y.

The magenta image forming section 10M is provided with the photoreceptor 11M, an electric-charging means 12M, an exposure means 13M, a developing means 14M, a primary transfer roller 15M as a primary transfer means and a cleaning means 16M.

The cyan image forming section 10C is provided with the photoreceptor 11C, an electric-charging means 12C, an exposure means 13C, a developing means 14C, a primary transfer roller 15C as a primary transfer means and a cleaning means 16C.

The black image forming section 10K is provided with the photoreceptor 11K, an electric-charging means 12K, an exposure means 13K, a developing means 14K, a primary transfer roller 15K as a primary transfer means and a cleaning means 16K.

Toner supplying means 141Y, 141M, 141C and 141K supply toners to the developing means 14Y, 14M, 14C and 14K, respectively.

Primary transfer rollers 15Y, 15M, 15C and 15K each selectively operate according to the type of image by a control means not shown in the drawing and the intermediate transfer belt 170 is compressed onto the respective photoreceptors 11Y, 11M, 11C and 11K to transfer an image onto the photoreceptor.

Thus, the respective color images formed on the photoreceptors 11Y, 11M, 11C and 11K in the image forming sections 10Y, 10M, 10C and 10K are sequentially transferred to the rotating intermediate transfer belt 170 to form a combined color image.

Namely, a toner image held on the photoreceptor surface is primarily transferred onto the surface of an intermediate transfer belt 170 to hold the transferred toner image on the intermediate transfer belt 170.

Recording paper P, as a recording medium which is contained within a paper feeding cassette 151, is fed by a paper feeding means 15 and conveyed to a secondary transfer roller 117 as a secondary transfer means via plural intermediate rollers 122A, 122B, 122C, 122D and a resist roller 123. Then, a toner image which has been synthesized on an intermediate transfer member by the secondary transfer roller 117 is transferred together onto the recording paper P.

Thus, the toner image held on the intermediate transfer member is secondarily transferred onto the surface of a material to be subjected to transfer.

A secondary transfer means 6 causes the recording paper P to be compressed to the intermediate transfer belt 170 only when the recording paper P passes here and is subjected to secondary transfer.

The recording paper P onto which a color image is transferred is subjected to fixing by a fixing device 124, sandwiched between delivery rollers 125 to be eject onto a delivery tray 126 disposed outside the machine.

Meanwhile, after having transferred the color image onto the recording paper P by the secondary transfer roller 117, the intermediate transfer belt 170 which has separated the recording paper P through self stripping is subjected to cleaning to remove a residual toner by a cleaning means 8.

Herein, the intermediate transfer member may be replaced by an intermediate transfer drum of a rotatable drum-form.

In the following, there will be described constitution of primary transfer rollers 15Y, 15M, 15C and 15K as a primary transfer means in contact with the intermediate transfer belt 170, and the secondary transfer roller 117.

The primary transfer rollers 15Y, 15M, 15C and 15K, are formed by covering the circumferential surface of an electrically conductive core bar, e.g., stainless steel of 8 mm outer diameter with a 5 m thick semi-conductive elastic rubber exhibiting a rubber hardness of ca. 20-70° (Asker hardness C) and a volume resistance of ca. 10⁵-10⁹ ω·cm in the form of a solid or a foamed sponge, the semi-conductive rubber being obtained by dispersing a conductive filler such as carbon or incorporating an ionic conductive material in a rubber material such as polyurethane, EPDM or silicone.

The secondary transfer roller 117 is formed by covering the circumferential surface of an electrically conductive core bar, e.g., stainless steel of 8 mm outer diameter with a 5 m thick semi-conductive elastic rubber exhibiting a rubber hardness of ca. 20-70° (Asker hardness C) and a volume resistance of ca. 10⁵-10⁹ ·cm in the form of a solid or a foamed sponge, the semi-conductive rubber being obtained by dispersing a conductive filler such as carbon or incorporating an ionic conductive material in a rubber material such as polyurethane, EPDM or silicone.

### <Transfer Material>

A transfer material used in the present invention is a support holding a toner image, which is usually called an image support, a transfer material or a transfer paper. Specific examples thereof include plain paper of light and heavy paper, coated printing paper such as art paper and coated paper, commercially available Japanese paper or post card paper, plastic film used for OHP and fabric, but are not limited to these.

### EXAMPLES

The present invention is further described specifically with reference to examples, but the present invention is by no means limited thereto.

### <<Preparation of Intermediate Transfer Member>>

An intermediate transfer member was prepared in the procedure, as described below.

### <Preparation of Resin Substrate>

### (Resin Substrate 1)

There was prepared a 100 μm thick seamless belt comprised of commercially available poly(phenylene sulfide) (PPS) containing an electrically conductive substance, which was denoted as “resin substrate 1”.

### (Resin Substrate 2)

There was prepared a 100 μm thick seamless belt comprised of commercially available polyimide (PI) containing an electrically conductive substance, which was denoted as “resin substrate 2”.

### (Resin Substrate 3)

There was prepared a 100 μm thick seamless belt comprised of commercially available polyester containing an electrically conductive substance, which was denoted as “resin substrate 3”.

### <Preparation of Intermediate Transfer Member 1>

### (Preparation of Elastic Layer 1)

A 150 μm thick “elastic layer 1” comprised of chloroprene rubber was provided by a dip-coating method on the outer circumference of the above-prepared “resin substrate 1”.

### (Preparation of Intermediate Layer 1)

Subsequently, the “intermediate layer 1” was formed on the foregoing “elastic layer 1” by using a plasma discharge apparatus, as shown in FIG. 3.

As materials to form the intermediate layer 1, the following mixed gas composition for the intermediate layer was employed. The formation of the intermediate layer 1 was carried out under the following film forming condition. In the atmospheric plasma treatment apparatus, there was used a dielectric covering the individual electrode employed alumina which covered the single side at a 1 mm thickness by a ceramic thermal spray processing. After coverage, the spacing between electrodes was set to 1 mm. A dielectric-covered metal base material of the individual electrode was specifically for use in a stainless steel jacket having cooling function via water cycling, and a plasma treatment was performed, while controlling the electrode temperature during discharging by cooling water, whereby the “intermediate layer 1” (SiₓO_{y}) was prepared.

### [Mixed Gas Composition for Intermediate Layer]

| | |
|---|---|
| Discharge gas: nitrogen gas | 94.85% by volume |
| Film forming (raw material) | 0.15% by volume |
| gas: hexamethyldisiloxane | |
| Additive gas: oxygen gas | 5.00% by volume |

Each material gas was heated to form a vapor, and the discharge gas and the reaction gas were mixed/diluted while each gas was subjected to an after heat treatment to avoid condensation of the material, followed by being supplied to the discharge space.

### [Condition for Forming Intermediate Layer]

### Power Source on the First Electrode Side

Power source: high frequency power source PHF-6k produced by Haiden Laboratory

Frequency: 100 kHz (continuous mode)

Power density: 10 W/cm² (voltage Vp at this tome was 7 kV)

Electrode temperature: 70° C.

### Power Source on the Second Electrode Side

Power source: high frequency power source CF-5000-13M produced by Pearl Kogyo Co., Ltd.

Frequency: 13.56 MHz (continuous mode)

Power density: 5 W/cm² (voltage Vp at this tome was 1 kV)

Electrode temperature: 70° C.

### (Preparation of Hard Layer 1)

Subsequently, on the above “intermediate layer 1”, a “hard layer 1” was formed using the plasma CVD apparatus shown in FIG. 3.

The following mixed gas composition for a hard layer was used as hard layer forming materials. The formation of a hard layer was carried out under the following film forming condition. In the atmospheric plasma treatment apparatus, there was used a dielectric covering the individual electrode employed alumina which covered the single side at a 1 mm thickness by a ceramic thermal spray processing. After coverage, the spacing between electrodes was set to 1 mm. A dielectric-covered metal base material of the individual electrode was specifically for use in a stainless steel jacket having cooling function via water cycling, and a plasma treatment was performed, while controlling the electrode temperature during discharging by cooling water, whereby the “hard layer 1” (SiO₂) was prepared.

### [Mixed Gas Composition for Hard Layer]

| | |
|---|---|
| Discharge gas: nitrogen gas | 94.99% by volume |
| Film forming (raw material) | 0.01% by volume |
| gas: tetraethoxysilane (TEOS) | |
| Additive gas: oxygen gas | 5.00% by volume |

Each material gas was heated to form a vapor, and the discharge gas and the reaction gas were mixed/diluted while each gas was subjected to an after heat treatment to avoid condensation of the material, followed by being supplied to the discharge space.

### [Condition for Forming Hard Layer]

### Power Source on the First Electrode Side

Power source: high frequency power source PHF-6k produced by Haiden Laboratory

Frequency: 100 kHz (continuous mode)

Power density: 10 W/cm² (voltage Vp at this tome was 7 kV)

Electrode temperature: 70° C.

### Power Source on the Second Electrode Side

Power source: high frequency power source CF-5000-13M produced by Pearl Kogyo Co., Ltd.

Frequency: 13.56 MHz (continuous mode)

Power density: 10 W/cm² (voltage Vp at this tome was 2 kV)

Electrode temperature: 70° C.

According to the above procedures, “intermediate transfer member 1” in which “elastic layer 1”, “intermediate layer 1” and “hard layer 1” were formed on “resin substrate 1” which was made from polyphenylenesulfide (PPS) was prepared.

### <Preparation of Intermediate Transfer Member 2>

“Intermediate transfer member 2” was prepared in the same manner as the preparation of “intermediate transfer member 1” except that the thicknesses of the intermediate layer 1 and the hard layer 1 were varied as shown in Table 3.

### <Preparation of Intermediate Transfer Member 3>

“Intermediate transfer member 3” was prepared in the same manner as the preparation of “intermediate transfer member 1” except that “intermediate layer 3” was prepared by changing the intermediate layer forming mixed gas composition and the intermediate layer forming condition used for the preparation of “intermediate layer 1” as described below to obtain “intermediate transfer member 3”.

### [Mixed Gas Composition for Intermediate Layer]

| | |
|---|---|
| Discharge gas: nitrogen gas | 97.00% by volume |
| Film forming (raw material) | 3.00% by volume |
| gas: methane | |
| Additive gas: oxygen gas | 0.00% by volume |

### [Condition for Forming Intermediate Layer]

### Power Sources on the First Electrode Side

Power source: high frequency power source CF-5000-13M produced by Pearl Kogyo Co., Ltd.

Frequency: 13.56 MHz (continuous mode)

Power density: 10 W/cm² (voltage Vp at this tome was 2 kV)

Electrode temperature: 70° C.

### Power Sources on the Second Electrode Side

Power source: high frequency power source CF-5000-13M produced by Pearl Kogyo Co., Ltd.

Frequency: 13.56 MHz (continuous mode)

Power density: 5 W/cm² (voltage Vp at this tome was 1 kV)

Electrode temperature: 70° C.

### <Preparation of Intermediate Transfer Member 4>

In the above preparation of “intermediate transfer member 1”, while “intermediate layer 1” was formed, the mixed gas composition for the intermediate layer was changed so as to obtain the concentrations of carbon atoms sequentially 8% by volume, 5% by volume and 3.3% by volume from the elastic layer side to the hard layer side to obtain an intermediate layer constituted of 3 layers. “Intermediate transfer member 4” was prepared in the same manner as the preparation of “intermediate transfer member 1” with respect to other procedures.

### <Preparation of Intermediate Transfer Member 5>

In the above preparation of “intermediate transfer member 1”, while “intermediate layer 1” was formed, the mixed gas composition for the intermediate layer was changed so that the concentration of carbon atoms was continuously varied from 8% by volume to 3.3% by volume from the elastic layer side to the hard layer side to obtain an intermediate layer having an inclined structure. “Intermediate transfer member 5” was prepared in the same manner as the preparation of “intermediate transfer member 1” with respect to other procedures.

### <Preparation of Intermediate Transfer Member 6>

“Resin substrate 1” used in the above preparation of “intermediate transfer member 1” was replaced with “Resin substrate 2” constituted of a polyimide. Further, on the circumference of the above “Resin substrate 2”, “elastic layer 2” constituted of a commercially available nitrile rubber and having a thickness of 150 μm was formed via a dip coating method. “Intermediate transfer member 6” was prepared in the same manner as the preparation of “intermediate transfer member 1” with respect to other procedures.

### <Preparation of Intermediate Transfer Member 7>

“Resin substrate 1” used in the above preparation of “intermediate transfer member 1” was replaced with “Resin substrate 3” constituted of a polyester. Further, on the circumference of the above “Resin substrate 3”, “elastic layer 3” constituted of a commercially available ethylene-propylene copolymer rubber and having a thickness of 150 μm was formed by a dip coating method. “Intermediate transfer member 7” was prepared in the same manner as the preparation of “intermediate transfer member 1” with respect to other procedures.

### <Preparation of Intermediate Transfer Member 8>

“Intermediate transfer member 8” was prepared in the same manner as the preparation of “intermediate transfer member 1” except that, in the preparation of “intermediate transfer member 1”, only “hard layer 1” was formed without forming “intermediate layer 1”.

### <Preparation of Intermediate Transfer Member 9>

“Intermediate transfer member 9” was prepared in the same manner as the preparation of “intermediate transfer member 1” except that, in the preparation of “intermediate transfer member 1”, only “intermediate layer 1” was formed without forming “hard layer 1”.

### <Preparation of Intermediate Transfer Members 10-19>

“Intermediate transfer members 10-19” were prepared in the same manner as the preparation of “intermediate transfer member 1” except that the preparation conditions of “intermediate layer 1” and “hard layer 1” were changed so as to exhibit the concentrations of carbon atoms and layer thicknesses as shown in Table 3.

### <Preparation of Intermediate Transfer Member 20>

“Intermediate transfer member 20” was prepared in the same manner as the preparation of “intermediate transfer member 1” except that the hard layer was prepared according to the method described below.

### (Preparation of Hard Layer 1)

“Hard layer 2” was prepared using the atmospheric pressure plasma apparatus shown in FIG. 3.

The following mixed gas composition for a hard layer was used as hard layer forming materials. The formation of a hard layer was carried out under the following film forming condition. In the atmospheric plasma treatment apparatus, there was used a dielectric covering the individual electrode employed alumina which covered the single side at a 1 mm thickness by a ceramic thermal spray processing. After coverage, the spacing between electrodes was set to 1 mm. A dielectric-covered metal base material of the individual roll electrode was specifically for use in a stainless steel jacket having cooling function via water cycling, and a plasma treatment was performed, while controlling the electrode temperature during discharging by cooling water, whereby the “hard layer 2” (SiOₓC_{y}) was prepared.

### [Mixed Gas Composition for Hard Layer]

| | |
|---|---|
| Discharge gas: nitrogen gas | 94.99% by volume |
| Film forming (raw material) | 0.05% by volume |
| gas: tetraethoxysilane (TEOS) | |
| Additive gas: oxygen gas | 4.96% by volume |

Each material gas was heated to form a vapor, and the discharge gas and the reaction gas were mixed/diluted while each gas was subjected to an after heat treatment to avoid condensation of the material, followed by being supplied to the discharge space.

### [Condition for Forming Hard Layer]

### Power Source on the First Electrode Side

Power source: high frequency power source PHF-6k produced by Haiden Laboratory

Frequency: 100 kHz (continuous mode)

Power density: 10 W/cm² (voltage Vp at this tome was 7 kV)

Electrode temperature: 70° C.

### Power Source on the Second Electrode Side

Power source: high frequency power source CF-5000-13M produced by Pearl Kogyo Co., Ltd.

Frequency: 13.56 MHz (continuous mode)

Power density: 10 W/cm² (voltage Vp at this tome was 2 kV)

Electrode temperature: 70° C.

According to the above procedures, “intermediate transfer member 20” in which “elastic layer 1”, “intermediate layer 2” and “hard layer 2” were formed on “resin substrate 1” which was made from polyphenylenesulfide (PPS) was prepared.

In Table 3, listed are the “resin substrates”, the materials of the “elastic layers”, numbers of layers, composition, concentrations of carbon atoms and thicknesses of the “intermediate layers” and the “hard layers” and the numbers of layers (sum of intermediate layer and hard layer) of the surface layers.

TABLE 3

| | | | Surface layer | | | | | | | | |
|---|---|---|---|---|---|---|---|---|---|---|---|
| | | | Intermediate layer | | | | Hard layer | | | | |
| | | | | | Carbon | | | | Carbon | | |
| | Substrate | | | | atoms | Layer | | | atoms | Layer | Layer |
| | Substrate | Elastic layer | Layer | | (atomic | thickness | Layer | | (atomic | thickness | thickness |
| | No. | Material | number | Composition | %) | (nm) | number | Composition | %) | (nm) | (nm) |
| ** 1 | 1 | Chloroprene rubber | 1 | SixOy | 8 | 300 | 1 | SiO₂ | <0.1 | 100 | 400 |
| ** 2 | 1 | Chloroprene rubber | 1 | SixOy | 8 | 200 | 1 | SiO₂ | <0.1 | 70 | 270 |
| ** 3 | 1 | Chloroprene rubber | 1 | Amorphous | 98 | 300 | 1 | SiO₂ | <0.1 | 100 | 400 |
| | | | | carbon | | | | | | | |
| ** 4 | 1 | Chloroprene rubber | 3 | SixOy | 8 | 150 | 1 | SiO₂ | <0.1 | 100 | 400 |
| | | | | SixOy | 5 | 100 | | | | | |
| | | | | SixOy | 3.3 | 50 | | | | | |
| ** 5 | 1 | Chloroprene rubber | * | SixOy | 8 | 300 | 1 | SiO₂ | <0.1 | 100 | 400 |
| ** 6 | 2 | Nitrile rubber | 1 | SixOy | 8 | 300 | 1 | SiO₂ | <0.1 | 100 | 400 |
| ** 7 | 3 | Ethylene-propylene | 1 | SixOy | 8 | 300 | 1 | SiO₂ | <0.1 | 100 | 400 |
| | | copolymer | | | | | | | | | |
| ** 8 | 1 | Chloroprene rubber | — | — | — | 6 | 1 | SiO₂ | <0.1 | 100 | 100 |
| ** 9 | 1 | Chloroprene rubber | 1 | SixOy | 8 | 300 | — | — | — | — | 300 |
| ** 10 | 1 | Chloroprene rubber | 1 | SixOy | 8 | 6 | 1 | SiO₂ | <0.1 | 2 | 8 |
| ** 11 | 1 | Chloroprene rubber | 1 | SixOy | 8 | 900 | 1 | SiO₂ | <0.1 | 100 | 1000 |
| ** 12 | 1 | Chloroprene rubber | 1 | SixOy | 8 | 4 | 1 | SiO₂ | <0.1 | 2 | 6 |
| ** 13 | 1 | Chloroprene rubber | 1 | SixOy | 8 | 1200 | 1 | SiO₂ | <0.1 | 100 | 1300 |
| ** 14 | 1 | Chloroprene rubber | 1 | SixOy | 8 | 300 | 1 | SiO₂ | 2 | 100 | 400 |
| ** 15 | 1 | Chloroprene rubber | 1 | SixOy | 8 | 300 | 1 | SiO₂ | <0.1 | 50 | 350 |
| ** 16 | 1 | Chloroprene rubber | 1 | SixOy | 8 | 300 | 1 | SiO₂ | 2.2 | 100 | 400 |
| ** 17 | 1 | Chloroprene rubber | 1 | SixOy | 8 | 300 | 1 | SiO₂ | <0.1 | 50 | 350 |
| ** 18 | 1 | Chloroprene rubber | 1 | SixOy | <0.1 | 300 | 1 | SiO₂ | 2.5 | 100 | 400 |
| ** 19 | 1 | Chloroprene rubber | 1 | SixOy | 8 | 0.3 | 1 | SiO₂ | <0.1 | 0.2 | 0.5 |
| ** 20 | 1 | Chloroprene rubber | 1 | SiOxCy | 12 | 300 | 1 | SiOxCy | 1.7 | 5 | 305 |

**: Intermediate transfer member,
*: Inclined structure

The thicknesses of the intermediate layer and the hard layer were determined by using the aforementioned micro-X-ray diffractometer MXP21 (produced by MAC Science Inc.) and by measuring the reflectance according to the aforementioned procedure.

In Table, 4, the elastic modulus, layer thickness and compression stress of each intermediate transfer member prepared as above were listed. Among the “intermediate transfer members 1-20”, the “intermediate transfer members 1-7, 10, 11, 14, 15, 19 and 20” which met the constitution of the present invention were designated as “Examples 1-13”, respectively, and the “intermediate transfer members 8, 9, 12, 13 and 16-18” which did not meet the constitution of the present invention were designated as “Comparative Examples 1-7”, respectively.

TABLE 4

| | | | | | | Com- |
|---|---|---|---|---|---|---|
| | Inter- | Elastic modulus | | Layer density | | pression |
| | mediate | Inter- | | Inter- | | stress |
| | transfer | mediate | Hard | mediate | Hard | Surface |
| | member | layer | layer | layer | layer | layer |
| | No. | (GPa) | (GPa) | (g/cm³) | (g/cm³) | (MPa) |
| Examples 1 | 1 | 3 | 30 | 2 | 2.16 | 1 |
| Examples 2 | 2 | 3 | 20 | 1.98 | 2.16 | 1 |
| Examples 3 | 3 | 4.5 | 30 | 1.45 | 2.16 | 1 |
| Examples 4 | 4 | 3 | 30 | 1.97 | 2.16 | 1 |
| | | 5 | | 2.02 | | |
| | | 10 | | 2.12 | | |
| Examples 5 | 5 | 3 | 30 | 2 | 2.16 | 1 |
| Examples 6 | 6 | 3 | 30 | 1.98 | 2.16 | 1 |
| Examples 7 | 7 | 3 | 30 | 2 | 2.16 | 1 |
| Examples 8 | 10 | 3 | 30 | 2 | 2.15 | <1 |
| Examples 9 | 11 | 3 | 30 | 2 | 2.16 | 1 |
| Examples 10 | 14 | 3 | 8 | 2 | 2.07 | 2 |
| Examples 11 | 15 | 3 | 60 | 1.99 | 2.19 | 1 |
| Examples 12 | 19 | 3 | 30 | 2 | 2.16 | <1 |
| Examples 13 | 20 | 3 | 10 | 2 | 2.09 | 1 |
| Comparative | 8 | — | 30 | — | 2.16 | 1 |
| examples 1 | | | | | | |
| Comparative | 9 | 3 | 30 | 2 | — | 1 |
| examples 2 | | | | | | |
| Comparative | 12 | 3 | 30 | 2 | 2.15 | <1 |
| examples 3 | | | | | | |
| Comparative | 13 | 3 | 30 | 2 | 2.16 | 1 |
| examples 4 | | | | | | |
| Comparative | 16 | 3 | 6 | 1.99 | 2.05 | 1 |
| examples 5 | | | | | | |
| Comparative | 17 | 3 | 72 | 20 | 2.19 | 50 |
| examples 6 | | | | | | |
| Comparative | 18 | 20 | 8 | 2.15 | 2.10 | 4 |
| examples 7 | | | | | | |

The elastic modulus, layer thickness and compression stress of each intermediate transfer member each were obtained by the aforementioned measuring apparatus and measuring procedure.

### <<Evaluation Experimental>>

### <Image Forming Apparatus>

The aforementioned “intermediate transfer members 1-20” were each loaded to an image forming apparatus “bizhub PRO C6500 (produced by Konica Minolta Business Technologies, Inc)” and the variations of the following items before and after print formation were evaluated.

A two-component developer composed of a toner exhibiting a volume median diameter (D₅₀) of 4.5 μm and a coated carrier of 60 μm (D₅₀), in which the toner content was 6%, was used for image formation.

Printing was conducted under an environment of low temperature and low humidity (10° C., 20% RH) and high temperature and high humidity (33° C., 80% RH), and 160,000 sheets of printing was carried out. A transfer material used was high quality paper (64 g/m²) of A4 size.

An original print document employed was an original image composed of a text image with a pixel rate of 7% (3 point characters and 5 point characters each were 50%), a color poi trait photograph (a dot image containing half-tone), a solid white image and a solid black image, each accounting for ¼ equal part. The primary transfer factor, secondary transfer factor, lack of text image, blade cleaning property, cracks and toner filming were evaluated.

### <Evaluation of Primary Transfer Factor>

Evaluation of primary transfer factor was made by measuring the transfer factor at the initial time and after completion of printing of 160,000 sheets under low temperature and low humidity (10° C., 20% RH). When a solid image (20 mm×50 mm) exhibiting an image density of 1.30 was formed on a photoreceptor, a toner mass of a toner image formed on the photoreceptor and a toner mass of a toner remained on the photoreceptor after transferred to an intermediate transfer member were each measured, and a primary transfer factor was determined by the following equation:

Primary transfer factor (%)={[(toner mass of toner image formed on photoreceptor)−(toner mass of toner remained on photoreceptor)]/(toner mass of toner image formed on photoreceptor)}×100

A primary transfer factor of 95% or more was evaluated to be excellent.

### <Secondary Transfer Factor>

Evaluation of secondary transfer factor was made with respect to transfer factor at the initial time and after completion of printing of 160,000 sheets under low temperature and low humidity (10° C., 20% RH). When a solid image (20 mm×50 mm) exhibiting an image density of 1.30 was formed, a mass of a toner transferred onto a transfer material and a toner mass of a toner image formed on an intermediate transfer member were each measured and a secondary transfer factor was determined by the following equation:

Secondary transfer factor(%)=[(toner mass of toner image formed on intermediate transfer member−(toner mass remained on intermediate transfer member)/(toner mass of toner image formed on intermediate transfer member)]×100

A secondary transfer factor of 98% or more was evaluated to be excellent.

### <Evaluation of Lack of Text Image>

Evaluation regarding lack of text image was conducted in the following manner. When printing was conducted under high temperature and high humidity (33° C., 80% RH), 10 sheets at the initial stage and 10 sheets after completion of printing of 160,000 sheets were taken out, and text images were observed by a magnifier to evaluate an extent of occurrence of lack of text image and evaluated based on the following criteria:

A: number of lacks of text image being 3 or less in printed images of all of 10 sheets and being excellent,

B: number of lacks of text image being 4 or more and 19 or less in printed images of at least one sheet but being acceptable in practical use,

C: number of lacks of text image being 20 or more in printed images of at least one sheet and being unacceptable in practical use.

### <Evaluation of Blade Cleaning Property>

After performing printing under an environment of low temperature and low humidity (10° C., 20% RH), the surface of an intermediate transfer member which had been cleaned by blade-cleaning was visually observed to evaluate blade-cleaning property with respect to an extent of a toner remained on the surface and staining of printed images, due to cleaning trouble.

Further, occurrence of burr in blade cleaning was also evaluated to be cleaning trouble.

### Criteria for Evaluation:

A: No uncleaned residual toner being observed until printing 160,000 sheets and no staining due to printing trouble being observed in print images,

B: Slightly uncleaned residual toner being observed when printing 160,000 sheets but no staining due to printing trouble being observed in print images and being acceptable for practical use,

C: Uncleaned residual toner being observed when printing 100,000 sheets and image staining due to cleaning trouble being observed in print images and unacceptable in practice.

### <Evaluation of Occurrence of Cracks>

After performing printing of 160,000 sheets under an environment of low temperature and low humidity (10° C., 20% RH), the surface of an intermediate transfer member was visually observed. Occurrence of cracks was evaluated by the extent of occurrence and by the occurrence of image defect on the printed image due to the cracks. Following A and B were estimated to be acceptable.

### Criteria for Evaluation:

A: No occurrence of cracks being observed on intermediate transfer member surface,

B: Occurrence of cracks being slightly observed but no occurrence of image defect due to cracks being observed, and being acceptable for practical use,

C: Notable occurrence of cracks being observed on intermediate transfer member, occurrence of image defects due to cracks being observed, and being unacceptable in practice.

### <Evaluation of Occurrence of Toner Filming>

After performing printing of 160,000 sheets under an environment of high temperature and high humidity (33° C., 90% RH), the surface of an intermediate transfer member was visually observed to evaluate the occurrence of toner filming, and occurrence of fog and white streak on the print image after 160,000 printing were also evaluated.

### Criteria for Evaluation:

A: no unevenness in gloss due to toner filming being observed and no occurrence of fog or white streak due to toner filming being observed on the print image,

B: slight unevenness in gloss due to toner filming being observed but no occurrence of fog or white streak being observed on the corresponding portion,

C: unevenness in gloss due to toner filming being observed and occurrence of fog or white streak being observed on the corresponding portion.

The results of above evaluation are shown in Table 5.

TABLE 5

| | Intermediate | | | | | | | | |
|---|---|---|---|---|---|---|---|---|---|
| | transfer | Primary transfer factor (%) | | Primary transfer factor (%) | | | | | |
| | member | | After 160,000 | | After 160,000 | Lack of text | Cleaning | | Toner |
| | No. | Initial | sheets printing | Initial | sheets printing | image | property | Cracks | filming |
| Example 1 | 1 | 99 | 98 | 98.5 | 98.5 | A | A | B | A |
| Example 2 | 2 | 99 | 98 | 98 | 98 | A | A | A | A |
| Example 3 | 3 | 99 | 98 | 98 | 98 | A | A | B | A |
| Example 4 | 4 | 99 | 98 | 98.5 | 98.5 | A | A | A | A |
| Example 5 | 5 | 99 | 98 | 98.5 | 98.5 | A | A | B | A |
| Example 6 | 6 | 99 | 98 | 98.5 | 98.5 | A | A | B | A |
| Example 7 | 7 | 99 | 98 | 98.5 | 98.5 | A | A | B | A |
| Example 8 | 10 | 99 | 98 | 98 | 97 | A | B | A | A |
| Example 9 | 11 | 99 | 98 | 99 | 98.5 | B | A | A | A |
| Example 10 | 14 | 99 | 98 | 97.5 | 97 | A | B | A | B |
| Example 11 | 15 | 99 | 98 | 98.5 | 98.5 | A | B | A | A |
| Example 12 | 19 | 99 | 98 | 97.5 | 97 | B | B | B | B |
| Example 13 | 20 | 99 | 97 | 97.5 | 97 | B | B | B | B |
| Comparative | 8 | 99 | 96 | 98 | 95 | A | B | C | C |
| Example 1 | | | | | | | | | |
| Comparative | 9 | 96 | 94 | 95 | 93 | A | C | A | C |
| Example 2 | | | | | | | | | |
| Comparative | 12 | 99 | 95 | 98 | 95 | A | C | A | C |
| Example 3 | | | | | | | | | |
| Comparative | 13 | 99 | 98 | 99 | 98 | C | A | A | A |
| Example 4 | | | | | | | | | |
| Comparative | 16 | 97 | 94 | 95 | 92 | A | C | A | B |
| Example 5 | | | | | | | | | |
| Comparative | 17 | 99 | 98 | 99.5 | 99 | B | A | C | C |
| Example 6 | | | | | | | | | |
| Comparative | 18 | 99 | 98 | 99 | 98.5 | B | A | C | C |
| Example 7 | | | | | | | | | |

As is clear from Table 5, excellent results were obtained for every evaluation item of first transfer factor and second transfer factor at the initial time and after completion of printing of 160,000 sheets, cleaning property, lack of text image, occurrence of crack and occurrence of toner filming for intermediate transfer members 1-7, 10, 11, 14, 15, 19 and 20 which had been designated as Examples 1-13, respectively. On the other hand, intermediate transfer members 8, 9, 12, 13 and 16-18 which had been designated as Comparative Examples 1-7, respectively, which did not meet the construction of the present invention failed to exhibit the prescribed result in any one of the evaluation items, and showed different results from those of the intermediate transfer member of the present invention.

### EXPLANATION OF THE NUMERALS

170 Intermediate transfer member

175 Resin substrate

176 Elastic layer

177 Surface layer

178 Intermediate layer

178a First layer of intermediate layer

178b Second layer of intermediate layer

178c Third layer of intermediate layer

179 Hard layer

1. An intermediate transfer member used for transferring a toner image carried on a surface of an electrophotographic photoreceptor primarily to the intermediate transfer member, and secondarily transferring the toner image from the intermediate transfer member to a transfer material, wherein the intermediate transfer member is formed by providing an elastic layer on an outer circumference of a resin substrate and further thereon a surface layer, wherein
the surface layer has a layer thickness of 0.5 nm or more but 1000 nm or less,
the surface layer comprises an intermediate layer and a hard layer, the hard layer having a metal oxide as a main component, and
a layer density of the hard layer is 2.07 g/cm³ or more but 2.19 g/cm³ or less, while the layer density of the hard layer is larger than a layer density of the intermediate layer.

2. The intermediate transfer member of claim 1, wherein an elastic modulus of the hard layer is 8.0 GPa or more but 60.0 GPa or less, while the elastic modulus of the hard layer is larger than an elastic modulus of the intermediate layer.

3. The intermediate transfer member of claim 1, wherein a carbon content of the intermediate layer is larger than a carbon content of the hard layer.

4. The intermediate transfer member of claim 1, wherein the surface layer is formed by laminating one or more layers of a metal oxide, a carbon-containing organic metal and amorphous carbon.

5. The intermediate transfer member of any one of claim 1, wherein the hard layer is a lay containing silicon oxide as a main component.

6. The intermediate transfer member of claim 1, wherein the intermediate layer contains silicon oxide as a main component and further contains 1.0 atomic % to 20.0 atomic % of carbon atoms.

7. The intermediate transfer member of claim 1, wherein the surface layer is prepared via a plasma CVD method conducted under an atmospheric pressure or vicinity thereof, wherein two or more electric fields each having a different frequency are formed in the plasma CVD method.

8. The intermediate transfer member of claim 1, wherein a compression stress of the surface layer is 30 MPa or less.

9. The intermediate transfer member of claim 1, wherein the elastic layer is a layer formed of at least one of a chloroprene rubber, a nitrile rubber and an ethylene-propylene copolymer.

10. The intermediate transfer member of claim 1, wherein the resin substrate is formed of at least one of a polyimide, a polycarbonate and a poly(phenylene sulfide).
